(19) United States
(12) Patent Application Publication
(10) Pub. No.: US 2026/0189022 A1
(43) Pub. Date: Jul. 2, 2026

(54) SYSTEM AND METHOD FOR MANAGING ELECTRICAL ENERGY FLOW BETWEEN ENERGY SOURCES AND ELECTRICAL LOAD CATEGORIES

(71) Applicant: Easymetering LLC, Boca Raton, FL (US)

(72) Inventors: Byron Joaquin Rojas Rojas, Guayaquil (EC); Victor Adolfo Lucio Lara, Guayaquil (EC); Jonathan Cagua Ordoñez, Guayaquil (EC); David Daniel Lara Pazmiño, Durán (EC)

(21) Appl. No.: 19/435,966

(22) Filed: Dec. 30, 2025

Related U.S. Application Data
(60) Provisional application No. 63/740,385, filed on Dec. 31, 2024.

(51) Int. Cl. H02J 3/466; H02J 3/001; H02J 3/007; H02J 13/12; H02J 103/35

(52) U.S. Cl. CPC H02J 3/466; H02J 3/00125; H02J 3/0075; H02J 13/12; H02J 2103/35

(57) ABSTRACT

A system and method for managing electrical energy flow between energy sources and electrical load categories are disclosed. The system comprises a first energy management module operatively connected to a utility grid, one or more grid-tied distributed energy resources, and one or more off-the-grid distributed energy resources to establish controlled electrical energy flow using energy monitoring units, an automatic transfer switch, and an energy switch module. A second energy management module processes electrical parameters, availability conditions, user-defined configuration data, and contextual and external operational data to generate energy management analytics. Based on the energy management analytics, the system assigns priority designation to electrical load categories and determines energy distribution commands for source switching, connection or disconnection of distributed energy resources, and priority-based load energization. The system further enables predictive control, resilience during grid disturbances, and optimized utilization of distributed energy resources through coordinated monitoring, forecasting, and control.

### CROSS REFERENCE TO RELATED APPLICATION(S)

This This application claims priority to provisional U.S. patent application Ser. No. 63/740,385 filed on Dec. 31, 2024, entitled, “ARTIFICIAL INTELLIGENCE-BASED SYSTEM AND METHOD FOR DYNAMIC ELECTRICAL LOAD BALANCING IN DISTRIBUTED ELECTRICAL NETWORKS”, the disclosure of which is incorporated herein by reference in its entirety for all purposes”.

### TECHNICAL FIELD

Embodiments of the present disclosure relate to electrical energy management systems and more particularly relate to systems, devices, and methods for managing and controlling electrical energy flow between a plurality of energy sources and a plurality of electrical load categories.

### BACKGROUND

Electrical power distribution systems are increasingly required to operate in environments that incorporate a plurality of energy sources, including utility grids and distributed energy resources such as renewable generation and energy storage systems. Residential, commercial, and industrial facilities commonly rely on a combination of centralized grid power and locally available energy resources to support a wide range of electrical loads with varying criticality and operational requirements. As energy infrastructures evolve, there is a growing need for systems capable of coordinating energy supply, monitoring electrical conditions, and maintaining continuity of service across diverse operating scenarios.

At the same time, electrical loads within a facility are no longer uniform in importance or tolerance to power interruptions. Certain electrical loads require continuous and stable power delivery, while other electrical loads can tolerate temporary interruptions or reduced availability. Managing electrical energy flow across the plurality of energy sources and a plurality of electrical load categories presents increasing technical complexity, particularly in the presence of grid disturbances, fluctuating energy availability, and variable energy pricing structures.

In the existing technology, electrical distribution panels and energy management solutions exhibit several technical limitations that restrict their effectiveness in modern multi-source energy environments. Conventional load centers and automatic transfer systems typically operate using static rules or simple threshold-based logic. The automatic transfer systems lack an ability to adapt dynamically to changing grid conditions, energy availability, or load behavior, resulting in inefficient energy utilization and suboptimal load management during outages or peak demand periods. Such automatic transfer systems are often reactive rather than predictive, responding only after an electrical event has occurred.

Many existing solutions treat the distributed energy resources as isolated components rather than as part of a coordinated energy ecosystem. This fragmented approach limits the ability to balance energy generation, storage, and consumption across the system and increases a risk of undesirable operating conditions such as energy backfeed, unstable switching behavior, or underutilization of available energy resources.

Furter, as shown in FIG. 1, a first block diagram 100 of the traditional system for monitoring and managing the electrical grids is disclosed. The traditional system relies on one of: external and third-party systems for comprehensive energy management, such as automated off-the-grid backup, and the limited metering capabilities. The traditional system has a dynamic range of the one or more electrical loads but depends on expensive third-party systems to automate energy backup, creating potential multipoint failures. The traditional system lacks individual breaker-level energy monitoring and control, relying instead on opt-in monitoring for a main source only, which limits granularity and increases dependency on external equipment. The traditional system lacks features such as bidirectional metering for one or more circuit breakers, onsite observability via translucent doors, and isolated optical communication for enhanced durability. Additionally, the static indications and reliance on the external equipment restrict flexibility and fail to provide real-time insights into electrical consumption behavior, further limiting the adaptability and traditional system robustness.

Current energy monitoring technologies often provide raw electrical measurements without sufficient analytical processing to support informed decision-making. As a result, system operators and automated controllers may lack meaningful insight into energy usage trends, potential grid instability, or the long-term economic impact of operational decisions. This limitation is further exacerbated by the absence of mechanisms to incorporate external and contextual data, such as environmental conditions or utility pricing information, into energy management decisions.

Additionally, existing systems frequently lack fine-grained load prioritization capabilities. Electrical loads are commonly managed as a single group or through manually configured circuits, making it difficult to dynamically adjust power delivery based on changing conditions such as reduced energy availability or fluctuating demand. This can lead to unnecessary load shedding, reduced resilience during outages, and inefficient use of stored or generated energy.

Furthermore, many current energy management architectures rely heavily on centralized communication infrastructure or cloud connectivity. During network disruptions or utility grid failures, such systems may lose coordination capability, leading to degraded performance or loss of control at critical times. The inability to maintain localized operational intelligence during such disruptions represents a significant technical limitation.

Finally, existing solutions provide limited support for evaluating the economic implications of the energy management decisions. While some systems report energy consumption or billing data, they typically lack integrated mechanisms for analyzing cost impacts over time or correlating operational behavior with economic performance. This gap makes it difficult to assess the financial effectiveness of energy management strategies or to adapt system operation in response to changing cost conditions.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a system for managing electrical energy flow between a plurality of energy sources and a plurality of electrical load categories is disclosed. The system comprises a first energy management module and a second energy management module. The first energy management module is operatively connected with the plurality of energy sources comprising: a utility grid, one or more grid-tied distributed energy resources (DERs), one or more off-the-grid DERs, configured to establish the electrical energy flow to the plurality of electrical load categories.

In one aspect, the first energy management module comprising one or more first energy monitoring units, an automatic transfer switch (ATS), a first energy switch module, a first hardware processor, and a rectifier module. The second energy management module is operatively connected to the first energy management module. The second energy management module comprises a second hardware processor and a memory unit.

In another aspect, the one or more first energy monitoring units are operatively connected to the plurality of energy sources. The one or more first energy monitoring units are configured to determine one or more electrical parameters at a pre-defined sampling rate. The one or more electrical parameters comprise voltage, current, and frequency. The pre-defined sampling rate is up to one megahertz.

Yet another aspect, the ATS is operatively connected to the one or more first energy monitoring units. The ATS is configured to selectively connect one of: the utility grid to the plurality of electrical load categories, and the one or more off-the-grid DERs to at least one electrical load category within the plurality of electrical load categories.

Yet another aspect, the first energy switch module is operatively connected between the grid-tied DERs and the utility grid. The first energy switch module is configured to one of: electrically connect and electrically disconnect the one or more grid-tied DERs from the utility grid. The first energy switch module is configured to avert electrical energy flowback between the one or more off-the-grid DERs and the one or more grid-tied DERs during a utility grid outage.

In one aspect, the first hardware processor is operatively connected to the one or more first energy monitoring units, the ATS, the first energy switch module. The first hardware processor is configured to determine availability conditions of the utility grid and the one or more off-the-grid DERs. The first hardware processor is configured to transmit switching control signals to the ATS based on the determined availability condition of the utility grid and the one or more off-the-grid DERs. The first hardware processor is configured to transmit one or more connection control commands to the first energy switch module. The one or more connection control commands comprise one of: commands to disconnect the one or more grid-tied DERs from the utility grid during the utility grid outage and reconnect the one or more grid-tied DERs after the reconnection delay. Further, the first hardware processor is configured to execute a reconnection delay before re-engaging the utility grid to safeguard the at least one electrical load category within the plurality of electrical load categories from electrical failures and voltage spikes.

Yet another aspect, the first energy management module further comprises a rectifier module. The rectifier module is operatively connected to the utility grid and the one or more off-the-grid DERs. The rectifier module is configured to: a) convert alternating current (AC) electrical energy into direct current (DC) electrical energy, and b) provide the DC electrical energy to the first hardware processor and the second hardware processor to maintain operational continuity during power transitions and the utility grid outages.

In another aspect, the memory unit is operatively connected to the second hardware processor, wherein the memory unit comprises a set of instructions in form of a plurality of subsystems, configured to be executed by the second hardware processor. The plurality of subsystems comprises a data obtaining subsystem, a forecasting subsystem, a load prioritization subsystem, an optimization subsystem, a control instruction subsystem, an energy cost optimization subsystem, and an economic performance analysis subsystem.

Yet another aspect, the data obtaining subsystem configured to obtain: a) user-defined configuration data comprising DERs group data, first-priority loads group data, and second-priority loads group data, b) the availability conditions of the utility grid and the one or more off-the-grid DERs from the first hardware processor, c) the one or more electrical parameters from the one or more first energy monitoring units and one or more second energy monitoring units associated with the plurality of electrical load categories, and d) at least one of: contextual operational data, and external operational data from one or more data sources. The one or more first energy monitoring units and the one or more second energy monitoring units comprise bidirectional metering and isolated metering configured to determine at least one of: electrical energy consumption data and electrical energy generation data.

In another aspect, the forecasting subsystem is configured to process the obtained one or more electrical parameters, the availability conditions, and at least one of: the contextual operational data, and the external operational data, using one or more artificial intelligence models for forecasting energy management analytics. The contextual operational data comprises at least one of: historical load profiles, time information, voltage data of rechargeable power sources, utility energy pricing information, and demand pricing information. The external operational data comprises at least one of: weather data, utility grid uptime and downtime records, and broadcast data affecting electrical services. The energy management analytics comprises at least one of: predicting energy consumption data, predicting grid failure events, determining load prioritization, and optimizing use of one or more DERs. The forecasting subsystem is further configured to perform edge computing for at least one of: real-time data processing, immediate anomaly detection, and local data aggregation to diminish for operation during network disruptions.

In an embodiment, the one or more artificial intelligence models comprise at least one of: one or more ensemble methods comprising random forest methods, gradient boosting machine methods, and decision tree methods, and b) one or more deep learning models comprising at least one of: artificial neural network (ANN) models, recurrent neural network (RNN) models, long short term memory (LSTM) network models, and transformer-based architecture models. The one or more artificial intelligence models are trained using training data comprising at least one of: the historical load profiles comprising voltage data, current data, and frequency measurements, source availability logs comprising the utility grid uptime and downtime records, battery discharge curves, the weather data, historical usage logs, anomaly datasets for failure prediction, and interaction data for decision-making optimization.

Yet another aspect, the load prioritization subsystem is configured to assign priority designation to the plurality of electrical load categories based on the user-defined configuration data and available electrical energy at the one or more off-the-grid DERs. Each electrical load in the plurality of electrical load categories comprises: a) one or more circuit breakers configured to provide overcurrent protection, the one or more second energy monitoring units corresponding to the one or more circuit breakers, configured to measure electrical energy consumption with the bidirectional metering and the isolated metering, and b) one or more energy control modules corresponding to the one or more circuit breakers, configured to selectively control the electrical energy flow to each electrical load in the plurality of electrical load categories based on the assigned priority designation.

Yet another aspect, the optimization subsystem configured to determine one or more energy distribution commands based on the energy management analytics and the assigned priority designation to the plurality of electrical load categories. The one or more energy distribution commands comprise: a) energizing the plurality of electrical load categories comprising: one or more DERs groups, a first-priority loads group, and a second-priority loads group, based on the electrical energy being supplied from the utility grid, b) switching the ATS to supply the electrical energy from the one or more off-the-grid DERs based on the available electrical energy at the one or more off-the-grid DERs being within a first predefined threshold range, and configured to energize the first-priority loads group and configured to averting electrical energy flowback to the one or more off-the-grid DERs and de-energize the second-priority loads group, c) switching the ATS to supply the electrical energy from the one or more off-the-grid DERs based on available electrical energy at the one or more off-the-grid DERs being within a second predefined threshold range, and configured to energize a first prioritized sub-group and a second prioritized sub-group in the first-priority loads group and to de-energize a third-prioritized sub-group in the first-priority loads group, and d) switching the ATS to supply the electrical energy from the one or more off-the-grid DERs based on available electrical energy at the one or more off-the-grid DERs being within a third predefined threshold range, and configured to energize the first prioritized sub-group in the first-priority loads group and to de-energize the second prioritized sub-group and the third-prioritized sub-group in the first-priority loads group.

Yet another aspect, the control instruction subsystem configured to transmit the one or more energy distribution commands to the first hardware processor for at least one of: a) switching the ATS, b) selectively one of: connecting and disconnecting the one or more grid-tied DERs, and c) managing the electrical energy flow from the plurality of energy sources to the plurality of electrical load categories according to the assigned priority designation.

Yet another aspect, the energy cost optimization subsystem is configured to: a) process the utility energy pricing information and the demand pricing information, b) analyze electrical energy consumption history and electrical energy generation history derived from the one or more electrical parameters to generate electrical energy analysis data, c) compute an energy cost optimization threshold range based on the electrical energy analysis data with respect to the utility energy pricing information and the demand pricing information, and d) transmit a disconnection command to the first hardware processor to disconnect the one or more grid-tied DERs from the utility grid through the first energy switch module once electrical energy generation exceeds the energy cost optimization threshold range.

Yet another aspect, the economic performance analysis subsystem is configured to generate economic performance analysis reports based on at least one of: the utility energy pricing information, the demand pricing information, net metering credits, electrical energy savings, and system installation costs.

Further, the second hardware processor is operatively connected to a communication gateway module. The communication gateway module configured to: a) provide network connectivity to system components and external devices using at least one of: wired communication protocols and wireless communication protocols, and b) forward inference requests from the external devices to the second hardware processor and return inference responses to the external devices.

In another embodiment of the present disclosure, a method for managing the electrical energy flow between the plurality of energy sources and the plurality of electrical load categories. In the first step, the method includes establishing, by the first energy management module is operatively connected with the plurality of energy sources comprising: the utility grid, the one or more DERs, and the one or more off-the-grid DERs, the electrical energy flow to the plurality of electrical load categories.

In the next step, the method includes determining, by the one or more first energy monitoring units are operatively connected to the plurality of energy sources, one or more electrical parameters at a pre-defined sampling rate. In the next step, the method includes selectively connecting, by the ATS operatively connected to the one or more first energy monitoring units, one of: a) the utility grid to the plurality of electrical load categories, and b) the one or more off-the-grid DERs to the at least one electrical load category within the plurality of electrical load categories.

In the next step, the method includes performing, by the first energy switch module operatively connected between the one or more grid-tied DERs and the utility grid, at least one of: a) one of: electrically connecting and electrically disconnecting the one or more grid-tied DERs from the utility grid, and b) averting the electrical energy flowback between the one or more off-the-grid DERs and the one or more grid-tied DERs during a utility grid outage.

In the next step, the method includes determining, by the first hardware processor operatively connected to the one or more first energy monitoring units, the ATS, and the first energy switch module, availability conditions of the utility grid and the one or more off-the-grid DERs.

In the next step, the method includes transmitting, by the first hardware processor, the switching control signals to the ATS based on the determined availability conditions of the utility grid and the one or more off-the-grid DERs. In the next step, the method includes transmitting, by the first hardware processor, the one or more connection control commands to the first energy switch module. In the next step, the method includes executing, by the first hardware processor, the reconnection delay before re-engaging the utility grid to safeguard the at least one electrical load category within the plurality of electrical load categories from electrical failures and voltage spikes.

In the next step, the method includes obtaining, by a data obtaining subsystem executed by the second hardware processor of the second energy management module operatively connected to the first energy management module: a) the user-defined configuration data comprising the DERs group data, the first-priority loads group data, and the second-priority loads group data, b) the availability conditions of the utility grid and the one or more off-the-grid DERs from the first hardware processor, c) the one or more electrical parameters from the one or more first energy monitoring units and the one or more second energy monitoring units associated with the plurality of electrical load categories, and d) at least one of: the contextual operational data, and the external operational data from the one or more data sources.

In the next step, the method includes processing, by the forecasting subsystem executed by the second hardware processor, the obtained one or more electrical parameters, the availability conditions, and at least one of: the contextual operational data, and the external operational data, using the one or more artificial intelligence models to forecast the energy management analytics.

In the next step, the method includes assigning, by the load prioritization subsystem executed by the second hardware processor, the priority designation to the plurality of electrical load categories based on the user-defined configuration data and the available electrical energy at the one or more off-the-grid DERs. In the next step, the method includes determining, by the optimization subsystem executed by the second hardware processor, the one or more energy distribution commands based on the energy management analytics and the assigned priority designation to the plurality of electrical load categories.

In the next step, the method includes transmitting, by a control instruction subsystem executed by the second hardware processor, the one or more energy distribution commands to the first hardware processor for at least one of: a) switching the ATS, b) selectively one of: connecting and disconnecting the one or more grid-tied DERs, and c) managing the electrical energy flow from the plurality of energy sources to the plurality of electrical load categories according to the assigned priority designation.

According to another embodiment of the present disclosure, a non-transitory computer-readable storage medium having the set of instructions stored therein that when executed by the first hardware processor and the second hardware processors, cause the first hardware processor and the second hardware processors to execute operations of: a) determining availability conditions of the utility grid and the one or more grid-tied DERs, b) transmitting switching control signals to the ATS based on the determined availability condition of the utility grid and the one or more off-the-grid DERs, c) transmitting the one or more connection control commands to the first energy switch module operatively connected between the one or more grid-tied DERs and the utility grid, to: one of: electrically connect and electrically disconnect the one or more grid-tied DERs from the utility grid and avert the electrical energy flowback between the one or more off-the-grid DERs and the one or more grid-tied DERs during the utility grid outage, d) executing the reconnection delay before re-engaging the utility grid to safeguard the at least one electrical load category within the plurality of electrical load categories from the electrical failures and the voltage spikes, e) obtaining the user-defined configuration data comprising the DERs group data, the first-priority loads group data, and the second-priority loads group data, f) obtaining the availability conditions of the utility grid and the one or more off-the-grid DERs, g) obtaining the one or more electrical parameters from the one or more first energy monitoring units and the one or more second energy monitoring units associated with the plurality of electrical load categories, h) obtaining at least one of: the contextual operational data, and the external operational data from the one or more data sources, i) processing the obtained the one or more electrical parameters, the availability conditions, and at least one of: the contextual operational data, and the external operational data, using the one or more artificial intelligence models to forecast the energy management analytics, j) assigning priority designation to the plurality of electrical load categories based on the user-defined configuration data and the available electrical energy at the one or more off-the-grid DERs, k) determining the one or more energy distribution commands based on the energy management analytics and the assigned priority designation to the plurality of electrical load categories, and l) transmitting the one or more energy distribution commands for: switching the ATS, selectively one of: connecting and disconnecting the one or more grid-tied DERs, and managing the electrical energy flow from the plurality of energy sources to the plurality of electrical load categories according to the assigned priority designation.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limited in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 illustrates an exemplary block diagram of a traditional system for monitoring and managing electrical grids, in accordance with a prior art;

FIG. 2A - FIG. 2E illustrate exemplary block diagrams of a system for managing electrical energy flow between a plurality of energy sources and a plurality of electrical load categories, in accordance with an embodiment of the present disclosure;

FIG. 3 illustrates an exemplary block diagram of a communication architecture of the system for managing the electrical energy flow between the plurality of energy sources and the plurality of electrical load categories, in accordance with an embodiment of the present disclosure;

FIG. 4 illustrates an exemplary block diagram representing internet access functionality of communication gateway module in the system, in accordance with an embodiment of the present disclosure;

FIG. 5 illustrates an exemplary first application of the communication gateway module, in accordance with an embodiment of the present disclosure;

FIG. 6 illustrates an exemplary second application of the second smart agent with the communication gateway module, in accordance with an embodiment of the present disclosure;

FIG. 7A - FIG. 7C illustrates an exemplary flowchart of the method for managing the electrical energy flow between the plurality of energy sources and the plurality of electrical load categories, in accordance with an embodiment of the present disclosure; and

FIG. 8 illustrates an exemplary block diagram representation of one or more server platforms for managing the electrical energy flow between the plurality of energy sources and the plurality of electrical load categories, in accordance with an embodiment of the present disclosure.

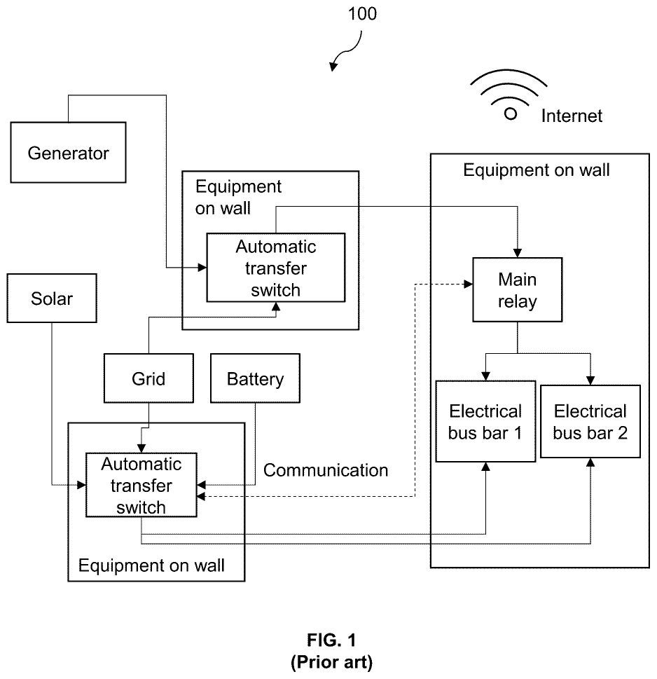

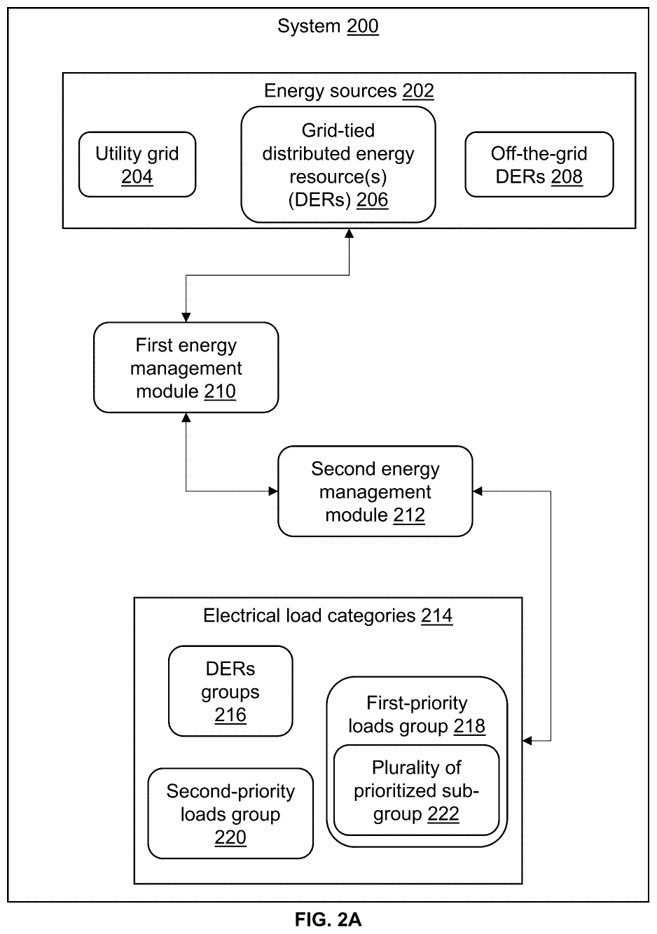

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises... a“ does not, without more constraints, preclude the existence of other devices, sub-systems, additional sub-modules. Appearances of the phrase ”in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module include dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

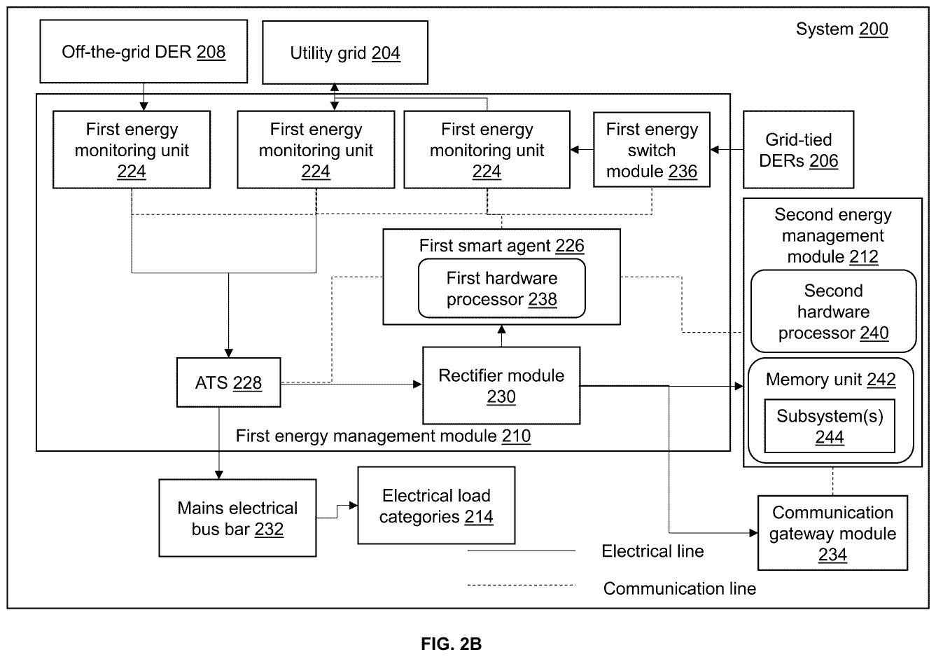

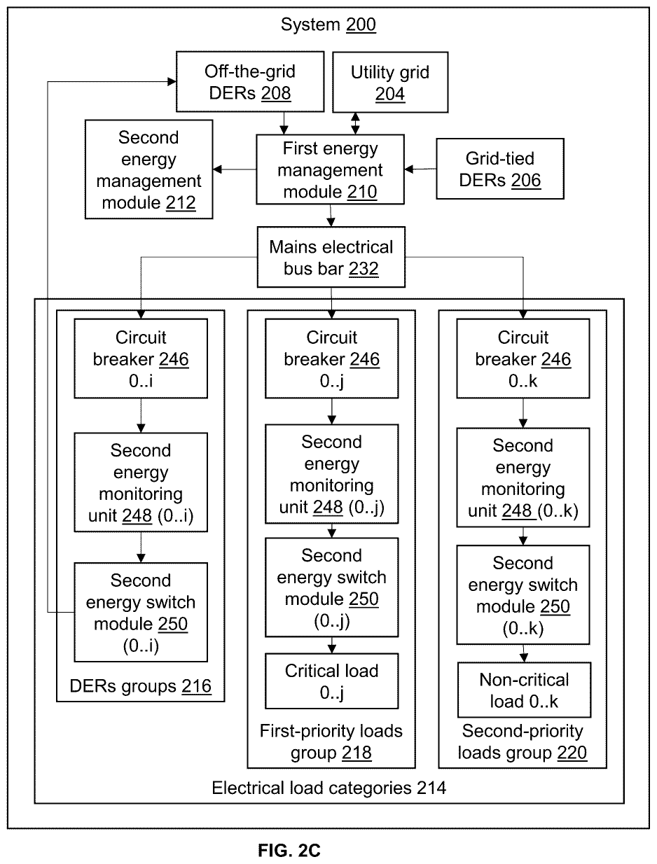

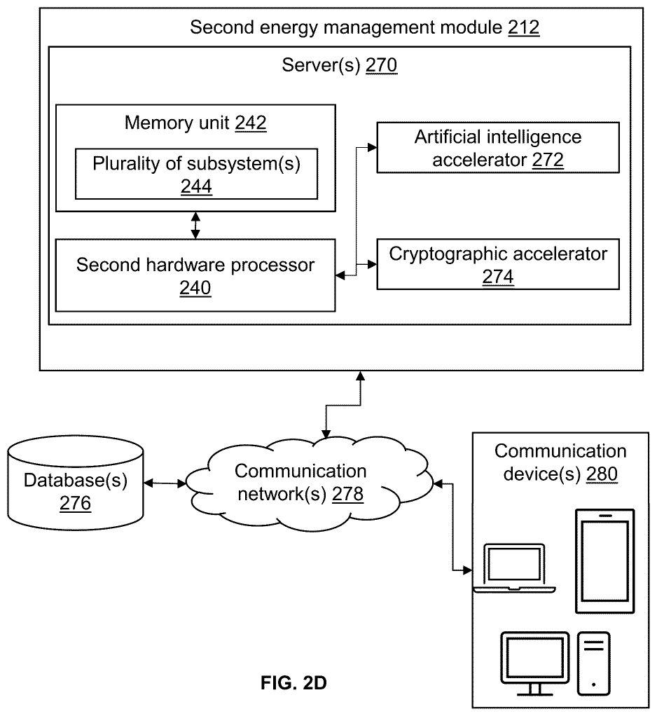

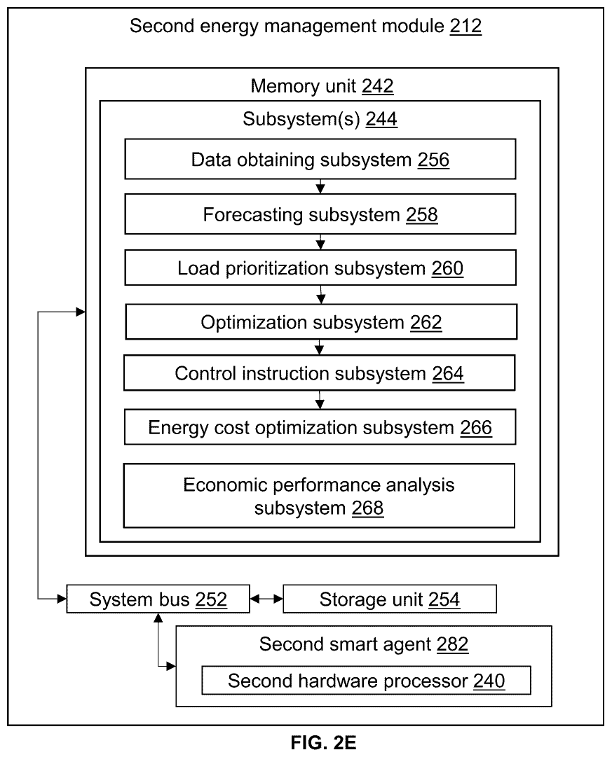

Referring now to the drawings, and more particularly to FIG. 2 through FIG. 8, where similar reference characters denote corresponding features consistently throughout the figures, there are shown preferred embodiments, and these embodiments are described in the context of the following exemplary system and/or method.

The present disclosure relates to a system for managing electrical energy flow between a plurality of energy sources and a plurality of electrical load categories. The system is structured to operate in environments where electrical energy is supplied from a utility grid, one or more grid-tied distributed energy resources (DERs), and one or more off-the-grid DERs, and where electrical loads are organized into multiple categories having different operational priorities. The system is configured to coordinate the distribution of electrical energy among the plurality of energy sources and the plurality of electrical load categories in a manner that supports continuity of service, adaptability to changing operating conditions, and efficient utilization of available energy.

The system further incorporates energy management modules that interact to enable monitoring, decision-making, and control across both the plurality of energy sources and the plurality of electrical load categories. Through this architecture, the system supports intelligent energy management functions, including forecasting, prioritization, optimization, and control, without reliance on static operating rules. The disclosed system provides a technical framework that enables predictive and adaptive management of electrical energy flow, supports integration of distributed energy resources, and facilitates informed energy distribution decisions across diverse operating scenarios.

FIG. 2A-FIG. 2E illustrate exemplary block diagrams of the system 200 for managing electrical energy flow between the plurality of energy sources 102 and the plurality of electrical load categories 214, in accordance with an embodiment of the present disclosure.

According to an exemplary embodiment of the present disclosure, the system 200 comprises the plurality of energy sources 102, a first energy management module 210, a second energy management module 212, and the plurality of electrical load categories 214. As depicted in FIG. 2A, the plurality of energy sources 102 is operatively connected to the plurality of electrical load categories 214 via the first energy management module 210 and the second energy management module 212. The plurality of energy sources 102 comprises the utility grid 204, the one or more grid-tied DERs 206, the one or more off-the-grid DERs 208.

In an exemplary embodiment, the one or more grid-tied DERs 206 comprise, but not limited to, at least one of: a solar energy generation system, a wind energy generation system, and the like, configured to operate while electrically coupled to the utility grid 204. The one or more off-the-grid DERs 208 comprise, but not limited to, at least one of: an electrical energy storage system, a backup power generation system, one or more internal combustion generator systems, and the like, configured to supply electrical energy independently of the utility grid 204.

In an exemplary embodiment, the plurality of electrical load categories 214 comprise, but not limited to, at least one of: one or more DERs groups 216, a first-priority loads group 218, a second-priority loads group 220, and the like. The one or more DERs groups 216 may comprise at least one of: the electrical energy storage system, the backup power generation system, and the like, configured to consume, store, or condition electrical energy within the system 200. The first-priority loads group 218 may comprise one or more electrical loads requiring continuous or near-continuous electrical energy supply, including loads that are sensitive to power interruptions. The first-priority loads group 218 may comprise a plurality of prioritized sub-group 222, which includes a first prioritized sub-group, a second prioritized sub-group, and a third-prioritized sub-group. The first prioritized sub-group, corresponding to a high critical load group, comprises electrical loads that require continuous or near-continuous electrical energy supply and are intolerant to interruptions, voltage deviations, or power quality disturbances. The second prioritized sub-group, corresponding to a medium critical load group, comprises electrical loads capable of tolerating limited interruptions, controlled load shedding, or reduced availability of electrical energy for short durations without compromising essential operation. The third prioritized sub-group, corresponding to a low critical load group, comprises electrical loads that are non-essential within the first-priority loads group and are capable of tolerating extended interruptions, deferred operation, or complete de-energization during constrained energy availability conditions, while remaining eligible for re-energization upon restoration of sufficient electrical energy availability.

In an exemplary embodiment, the first energy management module 210 is operatively connected with the plurality of energy sources 202. The first energy management module 210 is configured to establish the electrical energy flow from the plurality of energy sources 202 to the plurality of electrical load categories 214. As depicted in FIG. 2B, the first energy management module 210 comprising one or more first energy monitoring units 224, a first smart agent 226, an automatic transfer switch (ATS) 228, a rectifier module 230, and a first energy switch module 236. The first smart agent 226 comprises a first hardware processor 238 and is operatively coupled to the one or more first energy monitoring units 224, the ATS 228, the rectifier module 230. The first energy switch module 236 is configured to coordinate monitoring, decision execution, and control operations within the first energy management module 210.

In an exemplary embodiment, the one or more first energy monitoring units 224 are operatively connected to corresponding ones of the plurality of energy sources 202, including the utility grid 204 and the one or more off-the-grid DERs 208. Each first energy monitoring unit 224 of the one or more first energy monitoring units 224 is configured to determine one or more electrical parameters comprising voltage, current, frequency, and electrical energy values associated with the respective energy source. In an exemplary implementation, the one or more first energy monitoring units 224 comprise sensing circuitry, signal conditioning circuitry, and analog-to-digital conversion circuitry configured to sample the one or more electrical parameters at a predefined sampling rate of up to one megahertz. The measured one or more electrical parameters are transmitted to the first smart agent 226 as digital measurement data for real-time evaluation of source availability and quality.

In an exemplary embodiment, the first smart agent 226, implemented using the first hardware processor 238, is configured to receive the one or more electrical parameters from the one or more first energy monitoring units 224 and to determine availability conditions of the plurality of energy sources 202. In this context, the availability conditions include determinations related to the presence, stability, and suitability of the electrical energy from each energy source of the plurality of energy sources 202, such as, but not limited to, at least one of: detection of voltage deviations, frequency deviations, loss of grid power, and restoration of grid power, and the like. The first hardware processor 238 may execute firmware or control logic stored in non-volatile memory to continuously evaluate the received one or more electrical parameters against predefined operational thresholds and criteria.

In an exemplary embodiment, the first smart agent 226 is configured to operate as a control and coordination entity within the first energy management module 210 and is configured to manage source-side electrical energy flow based on real-time electrical conditions. The first smart agent 226 operates independently of predictive or optimization functions executed by the second energy management module 212, and is configured to perform immediate, hardware-level control actions required for safe and reliable source switching. The first smart agent 226 thus provides real-time responsiveness and electrical protection by executing source availability determination, switching control, and isolation functions within the first energy management module 210, while higher-level forecasting and optimization operations are performed by the second energy management module 212.

In an exemplary embodiment, the ATS 228 is operatively connected between the plurality of energy sources 202 via the one or more first energy monitoring units 224 and a mains electrical bus bar 232, and is further operatively connected to the first smart agent 226. The ATS 228 is configured to selectively connect at least one of the utility grid 204 or the one or more off-the-grid DERs 208 to the plurality of electrical load categories 214 via the mains electrical bus bar 232 based on switching control signals received from the first hardware processor 238 of the first smart agent 226. In an exemplary implementation, the ATS 228 comprises electromechanical switching components or solid-state switching components configured to electrically isolate one energy source before electrically coupling another energy source, thereby preventing simultaneous connection of incompatible sources.

In an exemplary embodiment, the first energy switch module 236 is operatively connected between the one or more grid-tied DERs 206 and the utility grid 204, and is further operatively connected to the first smart agent 226. The first energy switch module 236 is configured to selectively electrically connect and electrically disconnect the one or more grid-tied DERs 206 from the utility grid 204 based on one or more connection control commands generated by the first hardware processor 238 of the first smart agent 226. In an exemplary implementation, the first energy switch module 236 comprises one or more controllable switching devices configured to prevent electrical energy flowback between the one or more off-the-grid DERs 208 and the one or more grid-tied DERs 206, particularly during a utility grid outage or during transitional switching conditions.

In an exemplary embodiment, the rectifier module 230 is operatively connected to at least one of the utility grid 204 and the one or more off-the-grid DERs 208 via ATS 228 and is further operatively connected to the first smart agent 226, the second energy management module 212, and a communication gateway module 234. The rectifier module 230 is configured to convert alternating current (AC) electrical energy into direct current (DC) electrical energy. In an exemplary implementation, the rectifier module 230 provides regulated DC electrical energy to the first hardware processor 238 and to a second hardware processor 240 to maintain operational continuity of control, monitoring, and communication functions during one of: energy source transitions, utility grid disturbances, or the utility grid outages.

During operation, the first smart agent 226 executes control logic to generate the switching control signals for the ATS 228 and the one or more connection control commands for the first energy switch module 236 based on the determined availability conditions of the plurality of energy sources 202. The first smart agent 226 is further configured to execute a reconnection delay prior to re-engaging the utility grid 204 following a grid restoration event. The reconnection delay is implemented as a timed control operation executed by the first hardware processor 238 to allow stabilization of grid voltage and frequency before reconnection, thereby safeguarding at least one electrical load category within the plurality of electrical load categories 214 from electrical failures and voltage spikes.

The first energy management module 210, as described herein, operates as a source-side management and protection subsystem that performs real-time monitoring, availability determination, controlled source switching, and protective isolation functions. The coordinated operation of the one or more first energy monitoring units 224, the first smart agent 226, the ATS 228, the rectifier module 230, and the first energy switch module 236 enables controlled delivery of electrical energy to the mains electrical bus bar 232 and, in turn, to the plurality of electrical load categories 214, under varying operating conditions of the plurality of energy sources 202.

In an exemplary embodiment, the switching control signals for the ATS 228 are generated by the first smart agent 226 based on continuous evaluation of the one or more electrical parameters received from the one or more first energy monitoring units 224. The first hardware processor 238 executes control logic that compares the determined one or more electrical parameters associated with the utility grid 204, the one or more grid-tied DERs 206, and the one or more off-the-grid DERs 208 against predefined availability criteria. The predefined availability criteria may include threshold ranges for voltage magnitude, frequency stability, and continuity of electrical energy delivery, which are used to determine whether a corresponding energy source from the plurality of energy sources 202 is suitable for supplying the electrical energy to the mains electrical bus bar 232. For example, if the one or more electrical parameters associated with the utility grid 204 indicate a loss of voltage, a frequency deviation outside an acceptable range, or an interruption in service, the first smart agent 226 determines that the utility grid 204 is unavailable. Conversely, if the one or more electrical parameters indicate that the one or more off-the-grid DERs 208 are capable of supplying electrical energy within acceptable operating limits, the first smart agent 226 determines that the one or more off-the-grid DERs 208 are available.

Based on the determined availability conditions, the first smart agent 226 generates the switching control signals corresponding to a selected switching state of the ATS 228. The switching control signals are generated as digital control outputs from the first hardware processor 238 and are transmitted to control inputs of the ATS 228. In an exemplary implementation, the switching control signals cause the ATS 228 to electrically disconnect a currently connected energy source in the plurality of energy sources 202 before electrically connecting a newly selected energy source from the plurality of energy sources 202, thereby ensuring electrical isolation between energy sources during a switching operation.

The first smart agent 226 is further configured to inhibit generation of switching control signals that reconnect the utility grid 204 immediately following restoration of grid power. Instead, the first hardware processor 238 executes a reconnection delay by maintaining the ATS 228 in a non-grid-connected state for a predefined time interval. During the reconnection delay, the first smart agent 226 continues to monitor the one or more electrical parameters of the utility grid 204 to confirm stability before generating the switching control signal that reconnects the utility grid 204 to the mains electrical bus bar 232.

In an exemplary embodiment, the mains electrical bus bar 232 is electrically coupled to the ATS 228 and is configured to receive electrical energy from a selected one of the plurality of energy sources 202 under control of the first energy management module 210. The mains electrical bus bar 232 operates as a common electrical distribution node that conveys electrical energy from the ATS 228 to the plurality of electrical load categories 214. The mains electrical bus bar 232 provides a centralized conductive path for distributing electrical energy while maintaining electrical isolation and coordination between upstream energy source selection and downstream load-level control.

As depicted in FIG. 2B and FIG. 2C, the mains electrical bus bar 232 is operatively connected to the plurality of electrical load categories 214 through corresponding electrical conductors and protective elements. In an exemplary implementation, the mains electrical bus bar 232 is configured to supply the electrical energy to multiple downstream branch circuits, each branch circuit corresponding to the electrical load or a group of electrical loads within the plurality of electrical load categories 214. The mains electrical bus bar 232 is further configured to distribute the electrical energy without performing load prioritization or switching decisions, which are instead performed by control elements associated with the electrical load categories 214.

The mains electrical bus bar 232 is electrically positioned downstream of the ATS 228 such that only one selected energy source is electrically coupled to the bus bar at a given time. This configuration ensures that electrical energy from the utility grid 204 and electrical energy from the one or more off-the-grid DERs 208 are not simultaneously present on the mains electrical bus bar 232, thereby preventing electrical conflicts and unsafe operating conditions. The electrical characteristics of the mains electrical bus bar 232, including current-carrying capacity and insulation properties, are selected to accommodate the aggregate electrical demand of the plurality of electrical load categories 214.

As illustrated in FIG. 2C, each electrical load in the plurality of electrical load categories 214 comprises at least one of: one or more circuit breakers 246, one or more second energy monitoring units 248, one or more second energy switch module 250, and one or more energy control modules. Each of the one or more circuit breakers 246, each of the one or more second energy monitoring units 248, each of the one or more energy control modules, and each of the one or more second energy switch modules 250 is electrically and operatively associated with the corresponding electrical load or the group of electrical loads within the plurality of electrical load categories 214, and is electrically coupled downstream of the mains electrical bus bar 232.

In an exemplary embodiment, each of the one or more circuit breakers 246 is electrically connected between the mains electrical bus bar 232 and the corresponding electrical load. The one or more circuit breakers 246 are configured to provide overcurrent protection and electrical isolation for the corresponding electrical loads by interrupting electrical energy flow in response to fault conditions such as overcurrent, short circuits, or abnormal electrical conditions. The one or more circuit breakers 246 may comprise, but not limited to, one of: electromechanical circuit breakers, solid-state circuit breakers, and the like, and are selected based on the electrical characteristics of the corresponding electrical loads.

In an exemplary embodiment, the one or more second energy monitoring units 248 are operatively connected to corresponding to the one or more circuit breakers 246 and are configured to measure the electrical energy consumption associated with each electrical load or group of electrical loads. In an exemplary implementation, each of the one or more second energy monitoring units 248 comprises sensing circuitry configured for bidirectional metering and isolated metering, enabling measurement of the one or more electrical parameters including voltage, current, power, and accumulated electrical energy. The bidirectional metering enables detection of both electrical energy consumption and electrical energy generation at the load level, while the isolated metering provides electrical isolation between sensing circuitry and power conductors to ensure safety and signal integrity. Measurement data generated by the second energy monitoring units 248 is transmitted to the second energy management module 212 for analysis, forecasting, and optimization.

The one or more energy control modules corresponding to the one or more second energy switch modules 250 is operatively connected to the corresponding circuit breaker of the one or more circuit breakers 246 and the corresponding second energy monitoring unit of the one or more second energy monitoring units 248. The one or more energy control modules are configured to receive control instructions from the second energy management module 212 and to selectively control the electrical energy flow to the corresponding electrical load. In an exemplary implementation, the one or more energy control module generates actuation signals that enable or inhibit electrical energy delivery through the corresponding circuit breaker, or through associated switching elements, based on the assigned priority designation of the electrical load and the determined energy distribution commands.

The one or more second energy switch modules 250 are operatively connected in series with corresponding electrical loads and are configured to selectively connect or disconnect the corresponding electrical loads from the mains electrical bus bar 232 under control of the one or more energy control modules. In an exemplary implementation, each of the one or more second energy switch modules 250 comprises one or more controllable switching devices, such as relays or solid-state switches, which are capable of rapidly interrupting or restoring electrical energy flow. The one or more second energy switch modules 250 enable fine-grained, load-level control of the electrical energy distribution without requiring interruption of electrical energy supply to other electrical loads within the plurality of electrical load categories 214.

During operation, the electrical energy supplied to the mains electrical bus bar 232 is distributed to each electrical load through the one or more circuit breakers 246, the one or more second energy monitoring units 248, the one or more energy control modules, and the one or more second energy switch modules 250. The one or more second energy monitoring units 248 continuously measure electrical energy consumption data and transmit the measured data to the second energy management module 212. Based on the energy management analytics, priority designations, and optimization results generated by the second energy management module 212, the one or more energy control modules selectively actuate the one or more second energy switch modules 250 to connect or disconnect electrical loads in accordance with the assigned priority designation and available electrical energy.

Accordingly, the arrangement of the one or more circuit breakers 246, the one or more second energy monitoring units 248, the one or more energy control modules, and the one or more second energy switch modules 250 provides a distributed, load-level control architecture that enables selective monitoring, protection, and control of each electrical load within the plurality of electrical load categories 214, while supporting coordinated energy distribution decisions generated by the second energy management module 212.

In an exemplary embodiment, FIG. 2D illustrates an exemplary network architecture of the second energy management module 212. The network architecture may include one or more databases 276, and one or more communication devices 280. The one or more databases 276, and the one or more communication devices 280 may be communicatively coupled via one or more communication networks 278, ensuring seamless data transmission, processing, and decision-making. The second energy management module 212 acts as a central processing unit within the network architecture, responsible for managing the plurality of energy sources 202 and the plurality of electrical load categories 214 with a grid-failure predictions. The second energy management module 212 is configured to execute a set of computer-readable instructions that control a plurality of subsystems 244.

In an exemplary embodiment, the second energy management module 212 may be operatively connected to the one or more servers 270. The one or more servers 270 may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or the second hardware processor 240.

The one or more servers 270 comprises the second hardware processor 240 and a memory unit 242. The memory unit 242 is operatively connected to the second hardware processor 240. The memory unit 242 comprises the set of computer-readable instructions in the form of the plurality of subsystems 244, configured to be executed by the second hardware processor 240.

In an exemplary embodiment, the first hardware processor 238 and the second hardware processor 240 may include, for example, microprocessors, microcomputers, microcontrollers, digital signal processors, central processing units, state machines, logic circuits, and/or any devices that manipulate data or signals based on operational instructions. Among other capabilities, the first hardware processor 238 and the second hardware processor 240 may fetch and execute computer-readable instructions in the memory unit 242 operationally coupled with the system 200 for performing tasks such as data processing, input/output processing, and/or any other functions. Any reference to a task in the present disclosure may refer to an operation being or that may be performed on data. The second hardware processor 240 is a high-performance processors capable of handling large volumes of data and complex computations. The first hardware processor 238 and the second hardware processor 240 may be, but not limited to, at least one of: multi-core central processing units (CPU), graphics processing units (GPUs), and the like, which enhance an ability of the system 200 to process real-time data from one or more sources simultaneously.

In an exemplary embodiment, the one or more databases 276 may configured to store and manage data related to various aspects of the system 200. The one or more databases 276 may store at least one of, but not limited to, electrical parameter data obtained from the one or more first energy monitoring units 224 and the one or more second energy monitoring units 248, historical electrical energy consumption data, historical electrical energy generation data, availability condition data associated with the plurality of energy sources 202, load-level electrical usage data corresponding to the plurality of electrical load categories 214, and the like. The one or more databases 276 serve as a centralized repository for critical data elements that are integral to the secure operation of the system 200, enabling efficient management and synchronization of data associated with the system 200. The one or more databases 276 enable the system 200 to dynamically retrieve, analyze, and update the stored data in real-time, for managing the plurality of energy sources 202 and the plurality of electrical load categories 214 with the grid-failure predictions. The one or more databases 276 may include different types of databases such as, but not limited to, relational databases (e.g., Structured Query Language (SQL) databases), non-Structured Query Language (NoSQL) databases (e.g., MongoDB, Cassandra), time-series databases (e.g., InfluxDB), an OpenSearch database, object storage systems, and the like.

In an exemplary embodiment, the one or more communication devices 280 are configured to enable one or more users to interact with the system 200. The one or more communication devices 280 may be digital devices, computing devices, and/or networks. The one or more communication devices 280 may include, but not limited to, a mobile device, a smartphone, a personal digital assistant (PDA), a tablet computer, a phablet computer, a wearable computing device, a virtual reality/augmented reality (VR/AR) device, a laptop, a desktop, and the like. In an exemplary embodiment, the one or more communication devices 280 may be associated with, but not limited to, authorized users, system operators, administrators, or service personnel of the system 200.

In an exemplary embodiment, the one or more communication networks 278 may be, but not limited to, a wired communication network and/or a wireless communication network, a local area network (LAN), a wide area network (WAN), a Wireless Local Area Network (WLAN), a metropolitan area network (MAN), a telephone network, such as the Public Switched Telephone Network (PSTN) or a cellular network, an intranet, the Internet, a fiber optic network, a satellite network, a cloud computing network, a combination of networks, and the like. The wired communication network may comprise, but not limited to, at least one of: Ethernet connections, Fiber Optics, Power Line Communications (PLCs), Serial Communications, Coaxial Cables, Quantum Communication, Advanced Fiber Optics, Hybrid Networks, and the like. The wireless communication network may comprise, but not limited to, at least one of: wireless fidelity (wi-fi), cellular networks (including fourth generation (4G) technologies and fifth generation (5G) technologies), Bluetooth®, ZigBee®, long-range wide area network (LoRaWAN), satellite communication, radio frequency identification (RFID), 6G (sixth generation) networks, advanced IoT protocols, mesh networks, non-terrestrial networks (NTNs), near field communication (NFC), and the like.

In an exemplary embodiment, the system 200 may be implemented by way of a single device or a combination of multiple devices that may be operatively connected or networked together. The system 200 may be implemented in hardware or a suitable combination of hardware and software.

Though few components and the plurality of subsystems 244 are disclosed in FIGS. 2B, 2D and 2E, there may be additional components and subsystems which is not shown, such as, but not limited to, ports, routers, repeaters, firewall devices, network devices, the one or more databases 276, network attached storage devices, assets, machinery, instruments, facility equipment, emergency management devices, image capturing devices, any other devices, and combination thereof. The person skilled in the art should not be limiting the components/subsystems shown in FIG. 2A to FIG. 2E. Although FIG. 2A to FIG. 2E illustrates the system 200, and the one or more communication devices 280 connected to the one or more databases 276, one skilled in the art may envision that the system 200, and the one or more communication devices 280 may be connected to several user devices located at various locations and several databases via the one or more communication networks 278.

Those of ordinary skilled in the art will appreciate that the hardware depicted in FIG. 2A to FIG. 2E may vary for particular implementations. For example, other peripheral devices such as an optical disk drive and the like, the local area network (LAN), the wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the system 200 as is unique to the present disclosure or necessary for an understanding of the present disclosure is depicted and described. The remainder of the construction and operation of the system 200 may conform to any of the various current implementations and practices that were known in the art.

As depicted in FIG. 2E, the second energy management module 212 is operatively connected to the first energy management module 210. The second energy management module 212 comprises a system bus 252, a storage unit 254 and a second smart agent, which comprises the second hardware processor 240 and the memory unit 242. The memory unit 242 comprises the set of instructions in form of the plurality of subsystems 244, configured to be executed by the second hardware processor 240.

In an exemplary embodiment, the second hardware processor 240, the memory unit 242, and the storage unit 254 are communicatively coupled through the system bus 252 or any similar mechanism. The system bus 252 functions as the central conduit for data transfer and communication between the one or more second hardware processor 240, the memory unit 242, and the storage unit 254. The system bus 252 facilitates the efficient exchange of information and instructions, enabling the coordinated operation of the system 200. The system bus 252 may be implemented using various technologies, including but not limited to, parallel buses, serial buses, and high-speed data transfer interfaces such as, but not limited to, at least one of a: universal serial bus (USB), peripheral component interconnect express (PCIe), and similar standards.

In an exemplary embodiment, the memory unit 242 is operatively connected to the second hardware processor 240. The memory unit 242 comprises the plurality of subsystems 244 in the form of programmable instructions executable by the second hardware processor 240. The plurality of subsystems 244 comprises a data obtaining subsystem 256, a forecasting subsystem 258, a load prioritization subsystem 260, an optimization subsystem 262, a control instruction subsystem 264, an energy cost optimization subsystem 266, and an economic performance analysis subsystem 268. The second hardware processor 240 associated within the one or more servers 270, as used herein, means any type of computational circuit, such as, but not limited to, the microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The second hardware processor 240 may also include embedded controllers, such as generic or programmable logic devices or arrays, application-specific integrated circuits, single-chip computers, and the like.

The memory unit 242 may be the non-transitory volatile memory and the non-volatile memory. The memory unit 242 may be coupled to communicate with the second hardware processor 240, such as being a computer-readable storage medium. The second hardware processor 240 may execute machine-readable instructions and/or source code stored in the memory unit 242. A variety of machine-readable instructions may be stored in and accessed from the memory unit 242. The memory unit 242 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory unit 242 includes the plurality of subsystems 244 stored in the form of machine-readable instructions on any of the above-mentioned storage media and may be in communication with and executed by the second hardware processor 240.

The storage unit 254 may be a cloud storage or the one or more databases 276 such as those shown in FIG. 2D. The storage unit 254 may store, but not limited to, recommended course of action sequences dynamically generated by the system 200. The action sequences comprise electrical energy monitoring, electrical energy controlling, electrical energy management, report generating, and the like. Additionally, the storage unit 254 may retain previous action sequences for comparison and future reference, enabling continuous refinement of the system 200 over time. The storage unit 254 may be any kind of database such as, but not limited to, relational databases, dedicated databases, dynamic databases, monetized databases, scalable databases, cloud databases, distributed databases, any other databases, and a combination thereof.

In an exemplary embodiment, the data obtaining subsystem 256 configured to collect, aggregate, and normalize data inputs required by the plurality of subsystems 244 executed by the second energy management module 212. The data obtaining subsystem 256 operates as an interface layer between data sources internal to the system 200 and data sources external to the system 200, and is configured to obtain user-defined configuration data comprising DERs group data, first-priority loads group data, and second-priority loads group data.

In an exemplary aspect, the user-defined configuration data obtained by the data obtaining subsystem 256 comprises structured configuration information provided through the one or more communication devices 280 via a user interface, and stored in the one or more databases 276. The DERs group data defines logical groupings of distributed energy resources within the system 200, including associations between individual DERs and corresponding operational roles. The first-priority loads group data, and the second-priority loads group data, define load categorization and priority designation information used by downstream subsystems to determine permissible load energization states under varying energy availability conditions. In an exemplary implementation, the user-defined configuration data is retrieved as structured records or parameter sets and validated by the data obtaining subsystem 256 prior to distribution to other subsystems.

In an exemplary aspect, the data obtaining subsystem 256 is further configured to obtain availability conditions of the utility grid 204 and the one or more off-the-grid DERs 208 from the first hardware processor 238. The availability conditions of the utility grid 204 and the one or more off-the-grid DERs 208 are obtained from the first hardware processor 238, which determines such conditions based on real-time electrical parameter measurements and control logic executed within the first energy management module 210. The data obtaining subsystem 256 receives availability condition indicators representing source-level operating states, including indications of grid availability, grid instability, DER readiness, or DER capacity constraints. These availability conditions are formatted by the data obtaining subsystem 256 into standardized data representations suitable for use by the forecasting subsystem 258, the load prioritization subsystem 260, and the optimization subsystem 262.

In an exemplary aspect, the data obtaining subsystem 256 is further configured to obtain one or more electrical parameters from the one or more first energy monitoring units 224 and the one or more second energy monitoring units 248 associated with the plurality of electrical load categories 214. The one or more electrical parameters obtained from the one or more first energy monitoring units 224 and the one or more second energy monitoring units 248 comprise measured values of voltage, current, frequency, power, and accumulated electrical energy associated with both the plurality of energy sources 202 and the plurality of electrical load categories 214. The one or more first energy monitoring units 224 and the one or more second energy monitoring units 248 comprise bidirectional metering and isolated metering.

In this context, bidirectional metering refers to measurement capability that detects electrical energy flow in both directions, thereby enabling determination of electrical energy consumption data and electrical energy generation data at a given measurement point. The isolated metering refers to electrical isolation between sensing circuitry and power conductors, implemented using isolation components such as current transformers, voltage transformers, or isolation amplifiers, to protect measurement circuitry and ensure signal integrity. The one or more electrical parameters obtained via bidirectional and isolated metering is timestamped, digitized, and transmitted to the data obtaining subsystem 256 for aggregation and preprocessing.

In an exemplary aspect, the data obtaining subsystem 256 is further configured to obtain at least one of contextual operational data and external operational data from one or more data sources, including the one or more databases 276. The contextual operational data obtained by the data obtaining subsystem 256 comprises internally generated and historically accumulated data relevant to operation of the system 200, including historical load profiles, time information, voltage data of rechargeable power sources, utility energy pricing information, and demand pricing information. The external operational data comprises data originating from sources external to the system 200, including weather data, utility grid uptime and downtime records, broadcast data affecting electrical service, and other externally sourced indicators that may influence electrical energy availability or demand. In an exemplary implementation, the data obtaining subsystem 256 retrieves contextual operational data and external operational data from the one or more databases 276 through structured queries or data access interfaces, and associates the retrieved data with corresponding time intervals and system states.

In another exemplary aspect, the data obtaining subsystem 256 is further configured to perform data validation, time alignment, and normalization operations on the obtained data to ensure consistency across heterogeneous data sources. For example, the one or more electrical parameters sampled at high frequency may be aggregated or resampled to align with lower-frequency contextual operational data. The processed data is then provided as input to downstream subsystems, including the forecasting subsystem 258, the load prioritization subsystem 260, and the optimization subsystem 262, thereby enabling coordinated energy management analytics based on unified and coherent data representations.

In an exemplary embodiment, the forecasting subsystem 258 is configured to process the obtained one or more electrical parameters, the availability conditions, and at least one of: the contextual operational data, and the external operational data, using one or more artificial intelligence models for forecasting energy management analytics. The energy management analytics refers to computational analysis operations that generate forward-looking and decision-support outputs based on historical, real-time, and contextual data associated with the plurality of energy sources 202 and the plurality of electrical load categories 214. The energy management analytics comprises at least one of: predicting energy consumption data, predicting grid failure events, determining load prioritization, and optimizing use of one or more DERs, where such outputs are used by downstream subsystems to generate energy distribution commands.

In operation, the forecasting subsystem 258 receives time-stamped electrical parameter data, including voltage, current, frequency, and accumulated electrical energy values, together with the availability conditions indicating operating states of the utility grid 204 and the one or more off-the-grid DERs 208. The forecasting subsystem 258 further processes contextual operational data and external operational data, which provide temporal, environmental, and system-level context that influences electrical energy demand and availability. Based on these inputs, the forecasting subsystem 258 executes the one or more artificial intelligence models to generate predictive outputs, such as projected electrical energy demand over a future time interval, likelihood indicators of grid instability or failure events, and expected availability of distributed energy resources.

In an exemplary embodiment, the one or more artificial intelligence models comprise one or more ensemble methods, including, but not limited to, random forest methods, gradient boosting machine methods, decision tree methods, and the like. The one or more artificial intelligence models further comprise one or more deep learning models, including, but not limited to, artificial neural network (ANN) models, recurrent neural network (RNN) models, long short-term memory (LSTM) network models, transformer-based architecture models, and the like. The ensemble methods refer to models that combine outputs from multiple decision structures to improve prediction robustness, while the one or more deep learning models refer to multi-layer neural architectures capable of learning temporal and nonlinear relationships in sequential electrical energy data. For example, an LSTM network model may be used to learn long-term temporal dependencies in historical load profiles to forecast future energy consumption, while a random forest model may be used to classify grid operating conditions based on source availability logs and electrical parameter patterns.

In an exemplary embodiment, the random forest method comprises a plurality of decision trees trained on different subsets of training data and input features, and generates an output by aggregating the outputs of the plurality of decision trees. This aggregation improves robustness and reduces sensitivity to noise in the input data. In the context of the system 200, the random forest method may be used to analyze historical load profiles, source availability logs, and contextual operational data to predict future electrical energy consumption or to classify likelihood of grid instability events. The gradient boosting machine method comprises a sequence of decision tree models trained iteratively, where each successive model is trained to correct prediction errors of preceding models. This approach produces a strong predictive model by combining multiple weak learners. In the context of the system 200, the gradient boosting machine method may be used to optimize prediction accuracy for energy demand forecasting or failure prediction by learning complex nonlinear relationships between electrical parameters, contextual operational data, and historical outcomes.

The decision tree method represents a model in which input data is evaluated through a series of hierarchical decision nodes that split the data based on learned threshold values, resulting in an output such as a classification or a numerical prediction. In the context of the system 200, the decision tree method may be used to evaluate electrical parameter patterns and availability conditions to determine an operating state of an energy source or a load category. For instance, the historical electrical energy consumption data, availability condition data, and weather data may be provided as input features to a random forest method executed by the forecasting subsystem 258. The random forest method generates a predicted electrical energy demand value for a future time interval, which is then used by downstream subsystems to determine load prioritization and energy distribution commands.

In an exemplary embodiment, the ANN models comprise interconnected layers of computational nodes that apply weighted transformations to input data to generate predictive outputs. In the context of the system 200, the ANN models may be used to map the one or more electrical parameters and contextual operational data to predicted electrical energy consumption values. The RNN model is a neural network architecture that processes sequential data by maintaining an internal state representing prior inputs. This enables the RNN model to capture temporal dependencies in time-series data. In the present system 200, the RNN model may be used to analyze sequences of historical load profiles or the availability condition data to forecast short-term changes in electrical energy demand or source availability.

The LSTM network model is a type of recurrent neural network configured with gating mechanisms that regulate information flow, enabling the model to retain or discard information over extended time intervals. In the context of the system 200, the LSTM network model may be used to learn long-term temporal patterns in electrical energy consumption, battery discharge behavior, or grid uptime and downtime records to generate more accurate long-horizon forecasts. The transformer-based architecture model is a neural network architecture that processes input data using attention mechanisms to identify relationships between data elements without requiring sequential processing. In the present system 200, the transformer-based architecture model may be used to analyze the one or more electrical parameters and the contextual operational data across multiple time intervals to identify patterns indicative of future energy demand or grid failure events.

For instance, the time-stamped one or more electrical parameters, the historical load profiles, and the weather data may be provided as input to an LSTM network model executed by the forecasting subsystem 258. The LSTM network model generates a predicted electrical energy demand profile for a future time window, which is then used by downstream subsystems to support load prioritization and optimization of distributed energy resource usage.

The one or more artificial intelligence models are trained using training data comprising at least one of historical load profiles comprising voltage data, current data, and frequency measurements, source availability logs comprising the utility grid uptime and downtime records, battery discharge curves associated with the one or more off-the-grid DERs, weather data, historical usage logs, anomaly datasets for failure prediction, and interaction data for decision-making optimization. In an exemplary implementation, training is performed by iteratively adjusting model parameters to minimize prediction error with respect to known historical outcomes, after which trained model parameters are stored and used for inference during operation of the forecasting subsystem 258.

The forecasting subsystem 258 is further configured to perform edge computing for real-time data processing, immediate anomaly detection, and local data aggregation to support continued operation during network disruptions. The edge computing refers to execution of the one or more artificial intelligence models and associated data preprocessing operations locally at the second energy management module 212, rather than relying exclusively on remote computing resources. This enables the forecasting subsystem 258 to continue generating energy management analytics even when communication with external networks is degraded or unavailable.

In an exemplary embodiment, the second hardware processor 240 is operatively connected to an artificial intelligence accelerator 272, which is configured to enhance speed and performance of operations of the one or more artificial intelligence models. The artificial intelligence accelerator 272 may comprise specialized processing hardware configured to accelerate matrix operations, vector computations, or parallel execution of neural network layers. By offloading computationally intensive portions of model inference to the artificial intelligence accelerator 272, the forecasting subsystem 258 enables rapid processing of electrical energy usage patterns, load prioritization indicators, and predictive analytics outputs required for timely energy management decisions.

In an exemplary embodiment, the load prioritization subsystem 260 is configured to assign a priority designation to the plurality of electrical load categories 214 based on the user-defined configuration data and available electrical energy at the one or more off-the-grid DERs. The load prioritization subsystem 260 operates by evaluating predefined priority groupings specified in the user-defined configuration data in combination with real-time and derived indicators of available electrical energy capacity associated with the one or more off-the-grid DERs 208. The available electrical energy refers to an amount of electrical energy that can be supplied by the one or more off-the-grid DERs 208 without violating operational constraints, such as minimum allowable state-of-charge thresholds or discharge limits.

The load prioritization subsystem 260 operates by evaluating predefined priority groupings specified in the user-defined configuration data in combination with real-time and derived indicators of available electrical energy capacity associated with the one or more off-the-grid DERs 208. In this context, available electrical energy refers to an amount of electrical energy that can be supplied by the one or more off-the-grid DERs 208 without violating operational constraints, such as minimum allowable state-of-charge thresholds or discharge limits.

For instance, the load prioritization subsystem 260 computes one or more energy availability indicators based on battery state data and discharge characteristics associated with the one or more off-the-grid DERs 208. These one or more energy availability indicators are compared against predefined threshold ranges corresponding to different priority support levels. For example, if the available electrical energy exceeds a first threshold range (for instance 100% to 70%), the load prioritization subsystem 260 assigns priority designations that permit energization of the first-priority loads group 218 (critical loads) and de-energize the second-priority loads group 220 (non-critical loads). IF the available electrical energy falls within the second-threshold range (For instance 70% to 50%), the load prioritization subsystem 260 assigns priority designations that permit energization of the first prioritized sub-group and the second prioritized sub-group, and restrict energization to the third prioritized sub-group. Further, if the available electrical energy falls below the third threshold range (for instance below 50%), the load prioritization subsystem 260 assigns priority designations that restrict energization to the second prioritized sub-group and the third prioritized sub-group in the first-priority loads group 218.

The output of the load prioritization subsystem 260 comprises updated priority designation for each electrical load category within the plurality of electrical load categories 214. The priority designation indicates permissible energization states for each electrical load category and is transmitted to the optimization subsystem 262 for use in determining the one or more energy distribution commands. By separating configuration-defined priority groupings from dynamic energy-based evaluation, the load prioritization subsystem 260 enables adaptive load prioritization that reflects both user intent and real-time energy availability. Accordingly, the load prioritization subsystem 260 provides a deterministic and configurable mechanism for assigning the priority designations to the plurality of electrical load categories 214 under varying energy availability conditions, thereby supporting controlled load shedding, protection of the critical loads, and efficient utilization of electrical energy supplied by the one or more off-the-grid DERs 208.

In an exemplary embodiment, the optimization subsystem 262 is configured to determine the one or more energy distribution commands based on the energy management analytics generated by the forecasting subsystem 258 and the assigned priority designation determined by the load prioritization subsystem 260 for the plurality of electrical load categories 214. The optimization subsystem 262 operates by evaluating predictive outputs, including predicted energy consumption data, predicted grid failure events, and predicted availability of the one or more off-the-grid DERs 208, in combination with the priority designation of the plurality of electrical load categories 214, to select an appropriate energy distribution strategy that balances continuity of service and efficient utilization of the available electrical energy.

In operation, when the electrical energy being supplied to the plurality of electrical load categories 214 is sourced from the utility grid 204, the optimization subsystem 262 determines energy distribution commands that permit energization of the plurality of electrical load categories 214, including the one or more DERs groups 216, the first-priority loads group 218 corresponding to the critical loads, the second-priority loads group 220 corresponding to the non-critical loads. In this operating condition, the optimization subsystem 262 does not impose load shedding based on energy availability, as the utility grid 204 is treated as the primary and unconstrained energy source.

In an exemplary embodiment, when the energy management analytics indicate that electrical energy is to be supplied from the one or more off-the-grid DERs 208, the optimization subsystem 262 evaluates available electrical energy at the one or more off-the-grid DERs 208 relative to the predefined threshold ranges. The first predefined threshold range, which may correspond to an available electrical energy level between approximately, not restricted to, one hundred percent and seventy percent of usable capacity, represents a condition in which sufficient stored energy is available to support the plurality of prioritized sub-group 222 in the first-priority loads group 218. When the available electrical energy falls within the first predefined threshold range, the optimization subsystem 262 determines energy distribution commands that cause switching of the ATS 228 to supply the electrical energy from the one or more off-the-grid DERs 208, permit energization of the first-priority loads group 218, and prevent electrical energy flowback to the one or more off-the-grid DERs 208 or the one or more DERs groups 216 through coordinated control of source-side switching elements. Further, the optimization subsystem 262 is configured to de-energize the second-priority loads group 220 (the non-critical loads).

In a further exemplary embodiment, when the available electrical energy at the one or more off-the-grid DERs 208 falls within a second predefined threshold range, which may correspond to an available electrical energy level between approximately, not restricted to, seventy percent and fifty percent of usable capacity, the optimization subsystem 262 determines the one or more energy distribution commands that restrict electrical energy delivery to the third-prioritized sub-group (the low critical load group) in the first-priority loads group 218. Under this condition, the optimization subsystem 262 determines the one or more energy distribution commands that cause the ATS 228 to continue supplying electrical energy from the one or more off-the-grid DERs 208, permit energization of the first prioritized sub-group (the high critical load group) and the second prioritized sub-group (the medium critical load group) in the first-priority loads group 218, and cause de-energization of the third-prioritized sub-group in the first-priority loads group 218 and the second-priority loads group 220. This operating mode conserves remaining stored energy to maintain operation of the high critical load group and the medium critical load group for an extended duration.

In a further exemplary embodiment, when the available electrical energy at the one or more off-the-grid DERs 208 falls within a third predefined threshold range, below approximately fifty percent (not restricted to) of usable capacity, the optimization subsystem 262 determines the one or more energy distribution commands that restrict electrical energy delivery to the third-prioritized sub-group (the low critical load group) and the second prioritized sub-group (the medium critical load group) in the first-priority loads group 218. Under this condition, the optimization subsystem 262 determines the one or more energy distribution commands that cause the ATS 228 to continue supplying electrical energy from the one or more off-the-grid DERs 208, permit energization of the first prioritized sub-group (the high critical load group) in the first-priority loads group 218, and cause de-energization of the second prioritized sub-group (the medium critical load group) and the third-prioritized sub-group (the low critical load group) in the first-priority loads group 218 and the second-priority loads group 220. This operating mode conserves remaining stored energy to maintain operation of the high critical load group for an extended duration

The one or more energy distribution commands generated by the optimization subsystem 262 are structured control directives that are transmitted to the control instruction subsystem 264 for execution by the first energy management module 210 and load-side control elements. By selecting energy distribution strategies based on predictive analytics and dynamically assigned priority designation, the optimization subsystem 262 enables adaptive load management that responds to changing energy availability conditions while honoring user-defined prioritization and protecting critical electrical loads. Accordingly, the optimization subsystem 262 provides a decision-making layer that translates energy management analytics and the priority designation into the one or more energy distribution commands, enabling coordinated control of source selection, load energization, and load shedding within the system 200 under both normal and constrained operating conditions.

In an exemplary embodiment, the control instruction subsystem 264 configured to transmit the one or more energy distribution commands generated by the optimization subsystem 262 to the first hardware processor 238 for execution. The control instruction subsystem 264 operates as an instruction translation and dispatch layer that converts the one or more energy distribution commands into executable control signals and command messages compatible with the first energy management module 210. In this context, the one or more energy distribution commands represent structured control directives that specify required source selection actions, DER connection states, and load energization states based on the assigned priority designation of the plurality of electrical load categories 214.

In operation, the control instruction subsystem 264 formats the one or more energy distribution commands into control instructions that are transmitted to the first hardware processor 238 over a defined communication interface. The first hardware processor 238, upon receiving the control instructions, executes corresponding hardware-level control actions. For switching the ATS 228, the control instruction subsystem 264 transmits control instructions that cause the first hardware processor 238 to generate switching control signals for the ATS 228, thereby selecting the appropriate energy source from the plurality of energy sources 202 in accordance with the determined energy distribution strategy.

For selectively connecting or disconnecting the one or more grid-tied DERs 208, the control instruction subsystem 264 transmits connection control instructions to the first hardware processor 238, which in turn controls the first energy switch module 236 to establish or interrupt the electrical coupling between the one or more grid-tied DERs 206 and the utility grid 204. In an exemplary implementation, such control instructions are issued to prevent electrical energy flowback during grid outages, to isolate the one or more grid-tied DERs 206 during off-grid operation, or to reconnect the one or more grid-tied DERs 206 following satisfaction of reconnection conditions.

The control instruction subsystem 264 is further configured to support management of the electrical energy flow from the plurality of energy sources 202 to the plurality of electrical load categories 214 according to the assigned priority designation. In this context, the control instruction subsystem 264 transmits load-related control instructions that coordinate with load-side control elements to enforce energization or de-energization of the plurality of electrical load categories 214 based on priority designation determined by the load prioritization subsystem 260. For example, control instructions may specify that electrical energy be delivered only to the first-priority loads group 218 while de-energizing the non-critical loads under constrained energy availability conditions.

For instance, when the optimization subsystem 262 determines that available electrical energy at the one or more off-the-grid DERs 208 falls within a predefined low-energy threshold range, the control instruction subsystem 264 transmits energy distribution commands to the first hardware processor 238 that cause switching of the ATS 228 to the one or more off-grid DERs 208, disconnection of the one or more grid-tied DERs 206, and enforcement of priority-based load energization such that only the first-priority loads group remains energized. These coordinated actions are executed through hardware-level control by the first energy management module 210, based on instructions originating from the control instruction subsystem 264.

Accordingly, the control instruction subsystem 264 provides a deterministic and reliable mechanism for converting analytical and optimization outputs into executable control actions, enabling coordinated operation of source-side switching and load-side energy flow management in accordance with assigned priority designation and prevailing energy availability conditions within the system 200.

In an exemplary embodiment, the energy cost optimization subsystem 266 is configured to manage the electrical energy flow decisions based on economic considerations associated with utility energy pricing information and demand pricing information. The energy cost optimization subsystem 266 operates by processing pricing data that defines cost structures imposed by a utility provider, including time-based energy rates, demand-based charges, or other pricing parameters that affect cost of electrical energy consumption or export. The utility energy pricing information and the demand pricing information are obtained from the data obtaining subsystem 256 and represent external constraints that influence economically optimal operation of the system 200.

The energy cost optimization subsystem 266 is further configured to analyze electrical energy consumption history and electrical energy generation history derived from the one or more electrical parameters measured by the one or more first energy monitoring units 224 and the one or more second energy monitoring units 248. In this context, electrical energy consumption history represents historical records of electrical energy drawn by the plurality of electrical load categories 214, and electrical energy generation history represents historical records of electrical energy generated by the one or more grid-tied DERs 206 and the one or more off-the-grid DERs 208. The energy cost optimization subsystem 266 processes this historical data to generate electrical energy analysis data, which characterizes patterns of consumption, generation, and surplus energy over defined time intervals.

Based on the electrical energy analysis data and the utility energy pricing information and the demand pricing information, the energy cost optimization subsystem 266 computes an energy cost optimization threshold range. In this context, the energy cost optimization threshold range represents a quantitative condition at which electrical energy generation by the one or more grid-tied DERs 206 exceeds a level at which continued coupling to the utility grid 204 results in unfavorable economic outcomes, such as increased demand charges, reduced net metering benefits, or diminished economic efficiency. The energy cost optimization threshold range may be defined in terms of electrical energy magnitude, generation duration, or rate of generation relative to consumption.

When the electrical energy generation exceeds the computed energy cost optimization threshold range, the energy cost optimization subsystem 266 generates a disconnection command and transmits the disconnection command to the first hardware processor 238. The first hardware processor 238 executes the disconnection command by controlling the first energy switch module 236 to electrically disconnect the one or more grid-tied DERs 206 from the utility grid 204. This operation enables the system 200 to prevent economically disadvantageous energy export or demand-based billing events while allowing continued utilization of locally generated electrical energy for supplying the plurality of electrical load categories 214.

By way of an enablement example, the energy cost optimization subsystem 266 may determine, based on historical analysis, that electrical energy generation exceeding a predefined kilowatt threshold during peak demand pricing intervals results in increased demand charges. When real-time electrical energy generation data indicates that the one or more grid-tied DERs 206 are producing electrical energy beyond the energy cost optimization threshold range, the energy cost optimization subsystem 266 transmits a disconnection command to isolate the one or more grid-tied DERs 206 from the utility grid 204, thereby reducing exposure to unfavorable billing conditions. Accordingly, the energy cost optimization subsystem 266 enables economically informed control of grid interconnection by integrating pricing information with historical and real-time electrical energy data, thereby supporting cost-efficient operation of the system 200 without compromising load supply or system stability.

In an exemplary embodiment, the economic performance analysis subsystem 268 is configured to generate economic performance analysis reports that quantify financial outcomes associated with operation of the system 200. The economic performance analysis subsystem 268 operates by processing financial and operational data obtained from the data obtaining subsystem 256 and the one or more databases 276 to evaluate economic impacts of energy management decisions executed by the system 200. The generated economic performance analysis reports provide structured representations of cost savings, cost avoidance, and economic efficiency associated with electrical energy usage, generation, and management.

The economic performance analysis subsystem 268 processes utility energy pricing information and demand pricing information to determine baseline electrical energy costs that may be incurred under conventional operation without optimized energy management. The economic performance analysis subsystem 268 further processes net metering credits representing compensation or credits applied for electrical energy exported to the utility grid 204, electrical energy savings derived from reduced grid consumption or optimized load management, and system installation costs associated with deployment of the system 200. These data inputs are aggregated and normalized to enable comparative economic evaluation across defined time periods.

In operation, the economic performance analysis subsystem 268 computes economic metrics by correlating historical and current electrical energy consumption data and electrical energy generation data with corresponding pricing and credit information. For example, electrical energy savings are computed as a difference between baseline electrical energy costs and actual electrical energy costs incurred during operation of the system 200. The net metering credits are incorporated as positive economic contributions, and system installation costs are amortized over time to evaluate long-term economic performance.

The economic performance analysis reports (i.e., return on investment (ROI) reports) generated by the economic performance analysis subsystem 268 may include cost breakdowns, cumulative savings summaries, payback period estimates, and other economic indicators derived from the processed data. For example, the economic performance analysis subsystem 268 may generate the economic performance analysis reports indicating that optimized use of the one or more off-the-grid DERs 208 reduced peak demand charges during a billing cycle, resulting in a quantified monetary savings relative to a prior billing period. The economic performance analysis reports may further indicate an estimated return on investment based on accumulated savings and the system installation costs.

Accordingly, the economic performance analysis subsystem 268 enables evaluation of the financial performance of the system 200 by translating electrical energy management outcomes into economically meaningful metrics, thereby supporting informed decision-making, performance assessment, and long-term planning by users and system operators.

In operation, the system 200 manages electrical energy flow between the plurality of energy sources 202 and the plurality of electrical load categories 214 through coordinated interaction of the first energy management module 210 and the second energy management module 212. The first energy management module 210 performs real-time monitoring, source availability determination, and controlled switching of the utility grid 204, the one or more grid-tied DERs 206 and the one or more off-the-grid DERs 208 to safely supply the electrical energy to the mains electrical bus bar 232 and downstream plurality of electrical loads categories 214. Concurrently, the second energy management module 212 processes the one or more electrical parameters, the availability conditions, the user-defined configuration data, the contextual operational data, and the external operational data to generate energy management analytics, assign priority designation to the plurality of electrical load categories 214, and determine the optimized one or more energy distribution commands. The one or more energy distribution commands are transmitted to the first hardware processor 238 for execution, resulting in selective source switching, connection, or disconnection of the one or more grid-tied DERs 206, and priority-based energization or de-energization of electrical loads in the plurality of the electrical load categories 214. Through this integrated operation, the system 200 enables adaptive, predictive, and economically informed management of the electrical energy flow across normal operation, constrained energy conditions, and utility grid disturbances, while maintaining continuity of service for prioritized electrical loads and efficient utilization of available energy resources.

In an exemplary embodiment, the second hardware processor 240 is operatively connected to the communication gateway module 234, which functions as a communication interface between the second energy management module 212, other system components, and external devices. The communication gateway module 234 is configured to provide network connectivity using at least one of: wired communication protocols and wireless communication protocols, thereby enabling data exchange between internal subsystems of the system 200 and devices or services external to the system 200. The wired communication protocols may include Ethernet-based protocols or other physical-layer communication standards, and wireless communication protocols may include Wi-Fi, cellular communication, or other short-range or long-range wireless communication technologies

The communication gateway module 234 is further configured to forward inference requests received from external devices to the second hardware processor 240 for processing. In this context, an inference request refers to a structured data request submitted by an external device seeking analytical outputs generated by the plurality of subsystems 244 executed by the second hardware processor 240, such as energy management analytics, forecasting results, load prioritization information, or economic performance analysis data. Upon receiving an inference request, the communication gateway module 234 transmits the request data to the second hardware processor 240, which executes the corresponding computational tasks and generates inference responses.

After execution of the inference request, the communication gateway module 234 is configured to receive inference responses generated by the second hardware processor 240 and to transmit the inference responses back to the requesting external devices. The inference responses may comprise structured data outputs, status indicators, or analytical results derived from processing performed by the second energy management module 212. By facilitating bidirectional communication between the second hardware processor 240 and external devices, the communication gateway module 234 enables remote interaction with the system 200, supports external visualization or control interfaces, and allows integration of the system 200 with external monitoring, management, or supervisory platforms.

The communication gateway module 234 provides a communication infrastructure that supports reliable data exchange, remote inference execution, and interoperability between the second energy management module 212 and external devices, thereby enhancing accessibility, scalability, and operational flexibility of the system 200. In another exemplary embodiment, the communication gateway module 234 is configured to maintain reliable communication between the system 200 and the external devices 312 during partial or complete unavailability of the one or more communication networks 278. In this exemplary embodiment, the communication gateway module 234 enables local communication and coordination with the external devices 312 using direct or local communication interfaces, thereby allowing continued exchange of control signals, status information, and operational data independent of connectivity to the one or more communication networks 278. Through this configuration, the communication gateway module 234 supports uninterrupted operation, monitoring, and control of the external devices 312, thereby enhancing system reliability and operational continuity during network disruptions or communication outages.

In an exemplary embodiment, the second hardware processor 240 is operatively connected to a cryptographic accelerator 274. The cryptographic accelerator 274 is configured to safeguard sensitive data, including the user-defined configuration data, programmed instructions, and artificial intelligence models processing data through encryption. This ensures the integrity and security of the sensitive data, fostering trust and reliability in the operations.

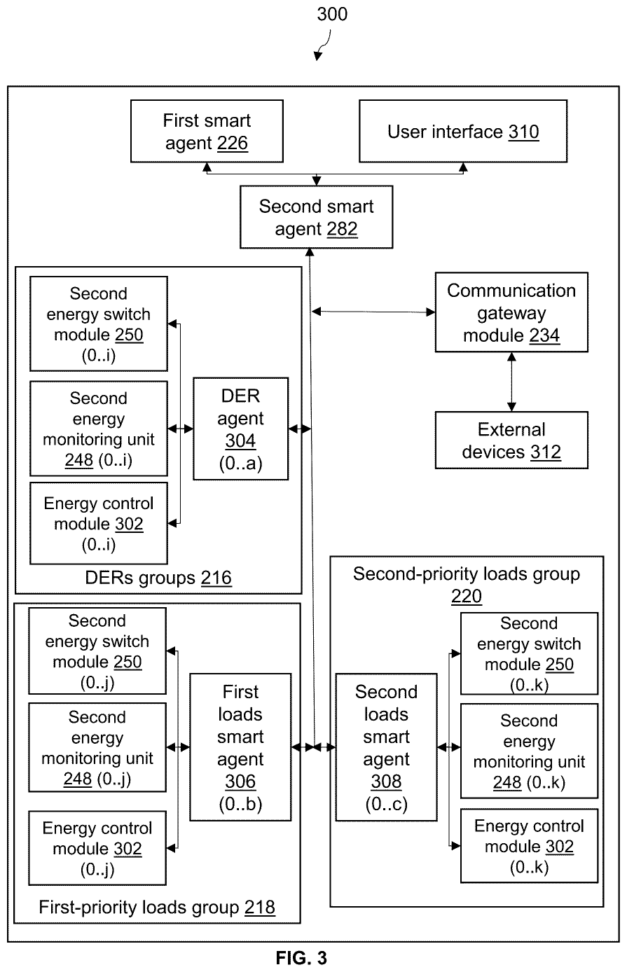

FIG. 3 illustrates an exemplary block diagram of a communication architecture 300 of the system 200 for managing the electrical energy flow between the plurality of energy sources 202 and the plurality of electrical load categories 214, in accordance with an embodiment of the present disclosure.

In an exemplary embodiment, the communication architecture 300 defines a hierarchical and distributed communication framework through which control, monitoring, and coordination functions are performed across source-side components, load-side components, and external interfaces of the system 200. In an exemplary embodiment, the communication architecture 300 comprises the first smart agent 226, the second smart agent 282, the communication gateway module 234, the user interface 310 associated with the one or more communication devices 280, and a plurality of agent-based control elements (304, 306, and 308) associated with the plurality of electrical load categories 214. The plurality of agent-based control elements (304, 306, and 308) comprising a DER agent 304, a first loads smart agent 306, and a second loads smart agent 308. The first smart agent 226 corresponds to source-side control logic associated with the first energy management module 210, while the second smart agent 282 operates as a central coordination entity that facilitates communication between source-side intelligence, load-side intelligence, and user-facing interfaces.

The second smart agent 282 is communicatively coupled to the first smart agent 226 and the user interface 310, enabling bidirectional exchange of control information, system status data, and configuration inputs. In this context, the user interface 310 provides an interaction point through which authorized users may view system state information, receive notifications, and provide user-defined configuration data that influences operation of the system 200. The second smart agent 282 aggregates and distributes such information to appropriate downstream agents and subsystems.

As depicted in FIG. 3, the plurality of electrical load categories 214 comprise the one or more DERs groups 216, the first-priority loads group 218, and the second-priority loads group 220. Each group includes the one or more second energy monitoring units 248, the one or more second energy switch modules 250, and the one or more energy control modules 302, which are configured to monitor and control electrical energy flow at the load level. These components are operatively connected to corresponding agent entities that provide localized intelligence and coordination.

In the one or more DERs groups 216, the DER agent 304 is communicatively coupled to the corresponding second energy monitoring units 248, the one or more second energy switch modules 250, and the one or more energy control modules 302. The DER agent 304 is configured to manage monitoring and control operations associated with distributed energy resources grouped within the one or more DERs groups 216, and to exchange operational data and control directives with the second smart agent 282. This arrangement enables coordinated management of DER-related loads and energy flow conditions.

In the first-priority loads group 218, the first loads smart agent 306 is communicatively coupled to the corresponding one or more second energy monitoring units 248, the one or more second energy switch modules 250, and the one or more energy control modules 302. The first loads smart agent 306 manages communication and control for critical electrical loads, ensuring that monitoring data and control instructions associated with the first-priority loads group 218 are prioritized and coordinated in accordance with the assigned priority designation.

Similarly, in the second-priority loads group 220, the second loads smart agent 308 is communicatively coupled to the corresponding one or more second energy monitoring units 248, the one or more second energy switch modules 250, and the one or more energy control modules 302. The second loads smart agent 308 manages communication and control operations for non-critical loads and coordinates with the second smart agent 282 to enforce load shedding or de-energization decisions under constrained energy availability conditions.

The second smart agent 282 is further communicatively coupled to the communication gateway module 234, which provides an interface between the internal communication architecture 300 and external devices 312. The communication gateway module 234 enables bidirectional data exchange between the system 200 and the external devices 312, allowing external systems or user devices to submit requests, receive system outputs, and interact with the communication architecture 300 through secure communication channels. The external devices 312 comprise at least one of: smart lighting devices, smart plugs, smart sockets, curtain control devices, motion sensors, humidifiers, air quality sensors, thermostats, tablet computing devices, smartphones, smart security cameras, temperature sensors, air conditioning systems, smart button devices, laundry appliances, humidity sensors, electric vehicle charging devices, fans, desktop computing devices, laptop computing devices, and other network-enabled devices configured to communicate with the communication gateway module 234 through the smart router or associated communication interfaces.

Accordingly, the communication architecture 300 illustrated in FIG. 3 provides a distributed agent-based communication framework that enables scalable, modular, and coordinated management of electrical energy flow across the plurality of energy sources 202 and the plurality of electrical load categories 214. By separating source-side intelligence, load-side intelligence, and external communication interfaces into cooperating smart agents and gateway modules, the system 200 achieves responsive control, efficient data exchange, and robust operation under varying energy and network conditions.

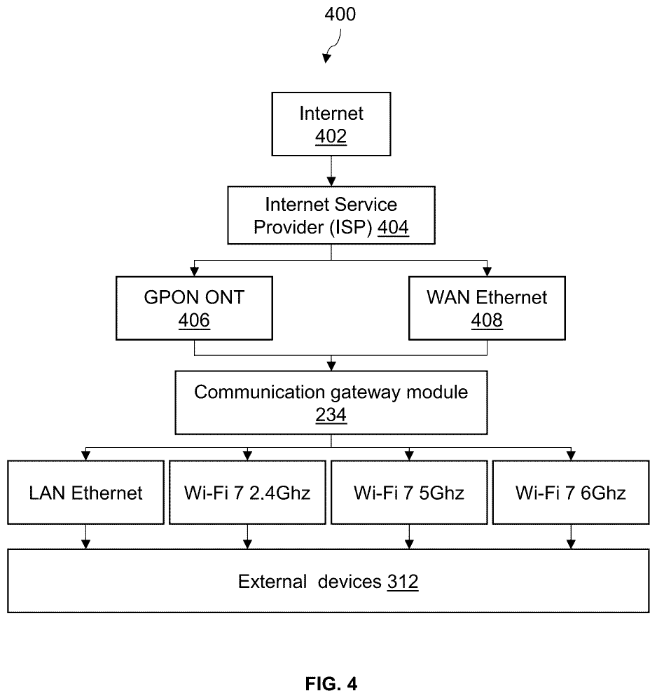

FIG. 4 illustrates an exemplary block diagram representing internet access functionality of the communication gateway module 234 in the system 200, in accordance with an embodiment of the present disclosure.

In an exemplary illustrated embodiment, the internet 402 is connected to an Internet Service Provider (ISP) 404, and the Internet Service Provider 404 is connected to the communication gateway module 234 through at least one of a Gigabit Passive Optical Network (GPON) Optical Network Terminal (ONT) 406 or a wide area network (WAN) Ethernet interface 408.

The communication gateway module 234 is configured to provide internet access to the external devices 312 through a plurality of communication interfaces and protocols. In an exemplary implementation, the communication gateway module 234 provides connectivity using at least one of a local area network (LAN) Ethernet interface, Wi-Fi 7 operating in 2.4-gigahertz, 5-gigahertz, and 6-gigahertz bands, and the like. The external devices 312 comprise one or more devices configured to access the internet 402 through the communication gateway module 234, thereby enabling network connectivity, data exchange, and remote interaction with the system 200.

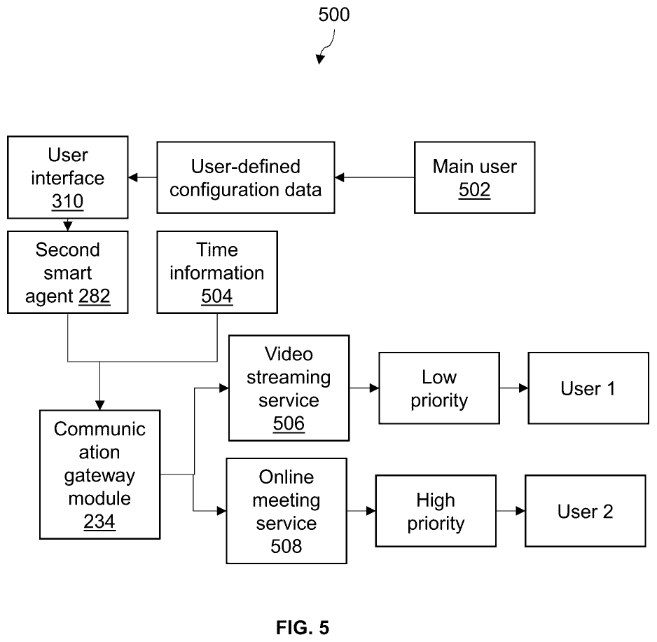

FIG. 5 illustrates an exemplary first application 500 of the communication gateway module 234, in accordance with an embodiment of the present disclosure.

In an exemplary illustrative embodiment, a main user 502 provides user-defined configuration data through the user interface 310, which is received by the second smart agent 282. The second smart agent 282 communicates the user-defined configuration data to the communication gateway module 234. The communication gateway module 234 further obtains time information 504, which may be used to determine temporal conditions associated with network usage and network service prioritization.

Based on the user-defined configuration data and the time information 504, the communication gateway module 234 assigns differentiated priority levels to network services. In the illustrated example, the communication gateway module 234 assigns a low priority to a video streaming service 506 and a high priority to an online meeting service 508. A first user consumes the video streaming service 506 under the assigned low-priority condition, while a second user consumes the online meeting service 508 under the assigned high-priority condition.

Through this configuration, the communication gateway module 234 enforces Quality of Service (QoS) control by allocating network resources according to the assigned priority levels. The QoS control configuration may be defined, modified, or managed through the user interface 310 or through an application-based interaction, thereby enabling user-configurable prioritization of network services within the system 200.

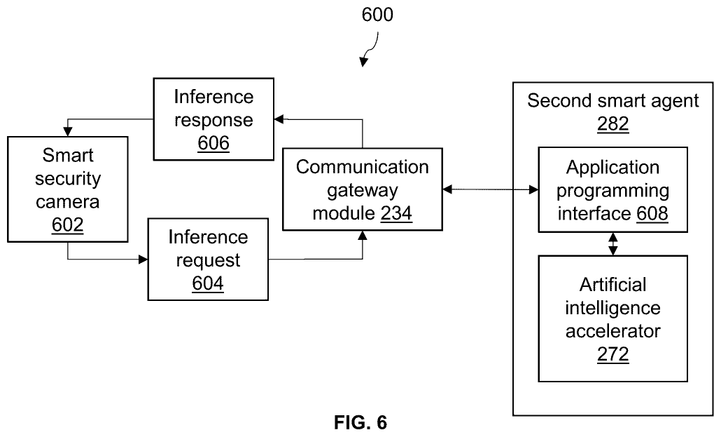

FIG. 6 illustrates an exemplary second application 600 of the second smart agent 282 with the communication gateway module 234, in accordance with an embodiment of the present disclosure.

In an exemplary illustrative embodiment, a smart security camera 602 generates and transmits an inference request 604 to the communication gateway module 234. The communication gateway module 234 forwards the inference request 604 to an application programming interface (API) 608 associated with the second smart agent 282. The second smart agent 282 processes the inference request 604 by executing one or more artificial intelligence models, with computational acceleration provided by the artificial intelligence accelerator 272.

Upon completion of processing, the second smart agent 282 generates an inference response 606 and transmits the inference response 606 back to the communication gateway module 234, which in turn delivers the inference response 606 to the smart security camera 602. Through this interaction, the smart security camera 602 utilizes the artificial intelligence processing capabilities of the second smart agent 282 without requiring dedicated artificial intelligence hardware at the smart security camera 602 itself, thereby enabling efficient inference execution and centralized intelligence within the system 200.

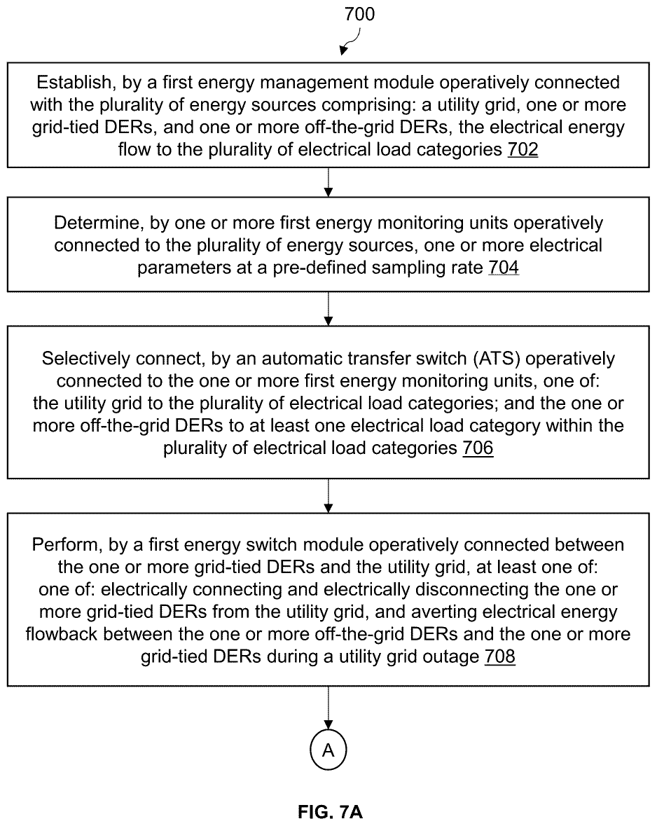

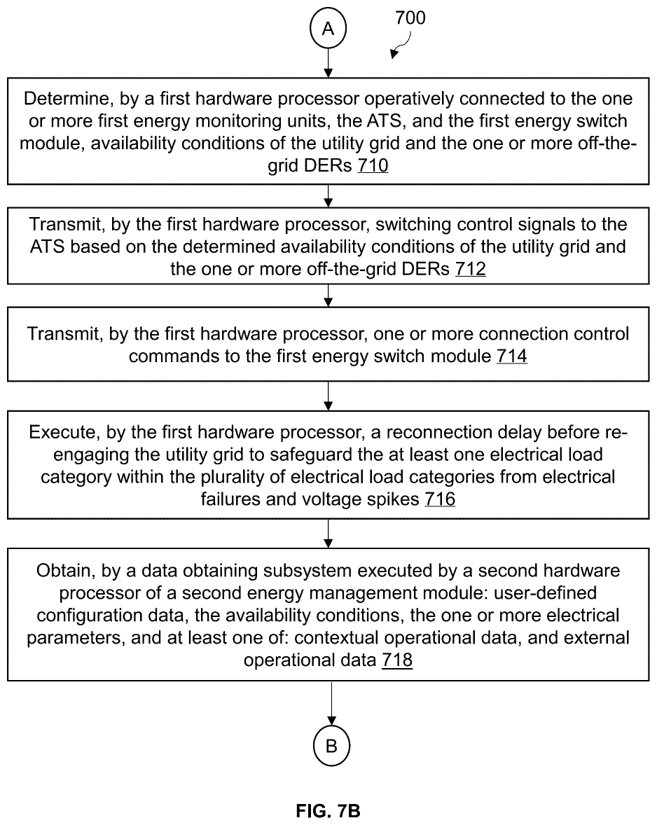

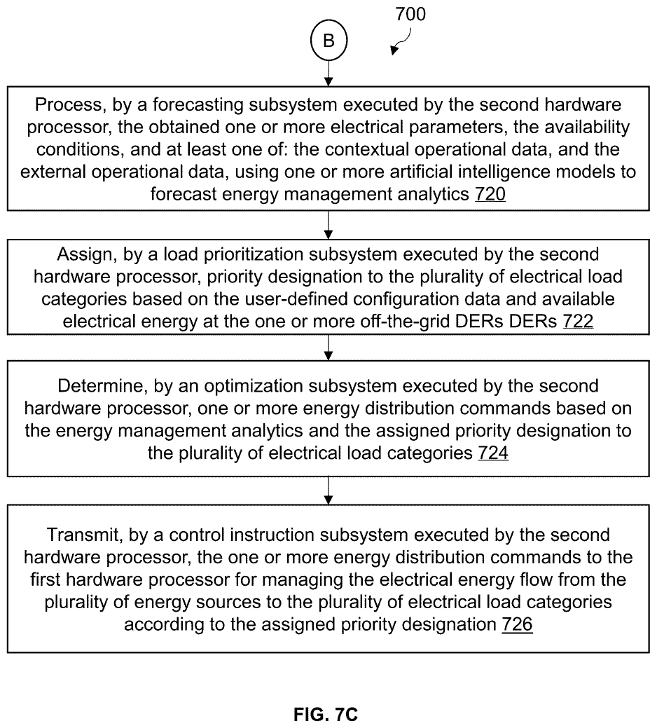

FIG. 7A-FIG. 7C illustrate exemplary flowcharts of a method 700 for managing the electrical energy flow between the plurality of energy sources and the plurality of electrical load categories, in accordance with an embodiment of the present disclosure.

According to another exemplary embodiment of the present disclosure, the method 700 for managing the electrical energy flow between the plurality of energy sources and the plurality of electrical load categories is disclosed. At step 702, the method 700 includes establishing, by the first energy management module operatively connected with the plurality of energy sources comprising the utility grid, the one or more DERs, and the one or more off-the-grid DERs, electrical energy flow to the plurality of electrical load categories.

At step 704, the method 700 includes determining, by the one or more first energy monitoring units operatively connected to the plurality of energy sources, the one or more electrical parameters at the pre-defined sampling rate. At step 706, the method 700 includes selectively connecting, by the ATS operatively connected to the one or more first energy monitoring units, one of: a) the utility grid to the plurality of electrical load categories, and b) the one or more off-the-grid DERs to the at least one electrical load category within the plurality of electrical load categories.

At step 708, the method 700 includes performing, by the first energy switch module operatively connected between the one or more grid-tied DERs and the utility grid, at least one of: a) one of: electrically connecting and electrically disconnecting the one or more grid-tied DERs from the utility grid, and b) averting the electrical energy flowback between the one or more off-the-grid DERs and the one or more grid-tied DERs during a utility grid outage.

At step 710, the method 700 includes determining, by the first hardware processor operatively connected to the one or more first energy monitoring units, the ATS, and the first energy switch module, availability conditions of the utility grid and the one or more off-the-grid DERs.

At step 712, the method 700 includes transmitting, by the first hardware processor, the switching control signals to the ATS based on the determined availability conditions of the utility grid and the one or more off-the-grid DERs. At step 714, the method 700 includes transmitting, by the first hardware processor, the one or more connection control commands to the first energy switch module. At step 716, the method 700 includes executing, by the first hardware processor, the reconnection delay before re-engaging the utility grid to safeguard the at least one electrical load category within the plurality of electrical load categories from electrical failures and voltage spikes.

At step 718, the method 700 includes obtaining, by the data obtaining subsystem executed by the second hardware processor of the second energy management module operatively connected to the first energy management module: a) the user-defined configuration data comprising the DERs group data, the first-priority loads group data, and the second-priority loads group data, b) the availability conditions of the utility grid and the one or more off-the-grid DERs from the first hardware processor, c) the one or more electrical parameters from the one or more first energy monitoring units and the one or more second energy monitoring units associated with the plurality of electrical load categories, and d) at least one of: the contextual operational data, and the external operational data from the one or more data sources.

At step 720, the method 700 includes processing, by the forecasting subsystem executed by the second hardware processor, the obtained one or more electrical parameters, the availability conditions, and at least one of: the contextual operational data, and the external operational data, using the one or more artificial intelligence models to forecast the energy management analytics.

At step 722, the method 700 includes assigning, by the load prioritization subsystem executed by the second hardware processor, the priority designation to the plurality of electrical load categories based on the user-defined configuration data and the available electrical energy at the one or more off-the-grid DERs. At step 724, the method 700 includes determining, by the optimization subsystem executed by the second hardware processor, the one or more energy distribution commands based on the energy management analytics and the assigned priority designation to the plurality of electrical load categories.

At step 726, the method 700 includes transmitting, by the control instruction subsystem executed by the second hardware processor, the one or more energy distribution commands to the first hardware processor for at least one of: a) switching the ATS, b) selectively one of: connecting and disconnecting the one or more grid-tied DERs, and c) managing the electrical energy flow from the plurality of energy sources to the plurality of electrical load categories according to the assigned priority designation.

In FIG. 7A-FIG. 7C, the circular symbols with “A and B” written inside are being used as an off-page connector. These are used for indicating that FIG. 7A continues in the subsequent pages as FIG. 7A-FIG. 7C.

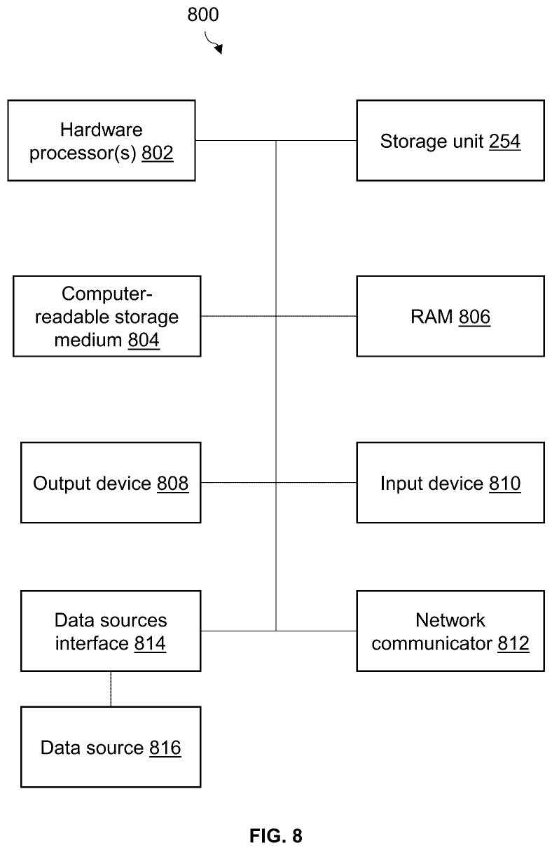

FIG. 8 illustrates an exemplary block diagram representation of one or more server platforms 800 for managing the electrical energy flow between the plurality of energy sources 202 and the plurality of electrical load categories 214, in accordance with an embodiment of the present disclosure.

In an exemplary embodiment, and for purposes of brevity, the construction, and operational features of the system 200 previously described are not repeated in detail herein. The functionalities of the system 200 may be executed on a wide variety of computing machines, including but not limited to internal or external server clusters, desktops, laptops, smartphones, tablets, edge devices, cloud-based computing nodes, or any combination thereof. As illustrated in FIG. 8, the one or more server platforms 800 may include additional components not shown and, in certain embodiments, one or more of the components depicted may be omitted, combined, or substituted as required for deployment. For example, a computer system equipped with the GPUs, or other hardware accelerators may reside on internal printed circuit boards (PCBs) or may be provisioned on external cloud environments such as Amazon® Web Services (AWS), Google® Cloud Platform (GCP), Microsoft® Azure, internal corporate cloud infrastructures, or organizational high-performance computing resources. Such configurable computing environments may be utilized to support the execution of the plurality of subsystems 244, including the data obtaining subsystem 256, the forecasting subsystem 258, the load prioritization subsystem 260, the optimization subsystem 262, the control instruction subsystem 264, the energy cost optimization subsystem 266, and the economic performance analysis subsystem 268.

The one or more server platforms 800 may represent a computer system, such as the system 200, that may be used to implement the embodiments described herein. The computer system may include a computational platform incorporating components that may reside on the one or more servers 270 or on any other suitable computing infrastructure. The computer system may utilize the one or more hardware processors 802 (e.g., the first hardware processor 238 and the second hardware processor 240) or other hardware processing circuits to execute the methods, functions, and operations described herein. These methods and operations may be embodied as machine-readable instructions stored on a non-transitory computer-readable storage medium, such as a random-access memory (RAM), a read-only memory (ROM), a flash memory, hard disk drives, solid-state drives, an erasable programmable read-only memory (EPROM), an electrically erasable programmable read-only memory (EEPROM), or other suitable storage technologies. The computer system may include the one or more hardware processors 802 that execute software instructions or code stored on a non-transitory computer-readable storage medium 804 to perform operations of the present disclosure.

In certain embodiments, the machine-readable instructions implement the plurality of subsystems 244. The one or more server platforms 800 collectively host, execute, and manage the operations necessary to obtain data, perform analytics, generate predictions, determine priority designation of the plurality of electrical load categories 214, optimize electrical energy distribution, transmit control instructions, and generate economic performance analysis associated with managing electrical energy flow between the plurality of energy sources 202 and the plurality of electrical load categories 214. The one or more server platforms 800 coordinate processing across the data obtaining subsystem 256, the forecasting subsystem 258, the load prioritization subsystem 260, the optimization subsystem 262, the control instruction subsystem 264, the energy cost optimization subsystem 266, and the economic performance analysis subsystem 268, thereby enabling integrated execution of monitoring, prediction, decision-making, and control functions.

In operation, the one or more hardware processors 802 execute the machine-readable instructions stored in the non-transitory computer-readable storage medium 804, the RAM 806, or the storage unit 254, while interacting with a network communicator 812 to exchange data with the external devices 312, the one or more databases 276, and external systems. A data sources interface 814 enables acquisition of data from the one or more data sources 816, including internal system components and external data providers. An output device 808 and an input device 810 facilitate interaction with users or external systems, including visualization of analytics, reports, and system status information. Through this architecture, the one or more server platforms 800 provide a scalable and flexible computing environment capable of supporting real-time and predictive energy management operations as described in the present disclosure.

The output device 808 may include a display integrated into the one or more communication devices 280, such as a laptop screen, desktop monitor, tablet display, or mobile device screen, and may present graphical user interfaces (GUIs), dashboards, textual summaries, or other visual elements that enable the user to interact with and interpret generated outputs by the second smart agent 282.

The computer system may further include the input device 808 through which one or more users or external systems may provide input data or otherwise interact with the second smart agent 282. The input device 810 may include, for example, a keyboard, keypad, mouse, touchscreen, stylus, or other suitable input peripherals. The users may employ the input device 810 to upload the user-defined configuration data, the electrical energy consumption history and the electrical energy generation history, and the like. Each of the output device 808 and the input device 810 may be supplemented with additional peripherals as required for specific deployment environments.

Numerous advantages of the present disclosure may be apparent from the discussion above. In accordance with the present disclosure, the systems, devices, and methods for managing and controlling electrical energy flow between the plurality of energy sources and the plurality of electrical load categories provide a coordinated and adaptive energy management framework capable of operating under varying grid conditions and energy availability states. The disclosed system enables integration of utility grid power, grid-tied distributed energy resources, and off-the-grid distributed energy resources within a unified control architecture, thereby supporting seamless source switching, controlled isolation, and protection against electrical disturbances.

The present disclosure further provides advantages in predictive and proactive energy management by incorporating forecasting, load prioritization, and optimization subsystems that utilize real-time electrical parameters, contextual operational data, and external operational data. This enables improved continuity of service for higher-priority electrical load categories during constrained energy conditions, while allowing selective de-energization of non-critical loads to conserve available energy resources. Additionally, the distributed monitoring and load-level control architecture facilitates fine-grained visibility and control of electrical energy consumption and generation across individual loads and load groups.

The system further offers advantages in scalability and interoperability through use of modular energy management modules, communication gateways, and agent-based communication architectures, allowing integration with external devices, network services, and computing platforms. By supporting edge computing and accelerated artificial intelligence processing, the system maintains operational responsiveness and decision-making capability during network disruptions. Collectively, these technical features enable reliable, efficient, and intelligent management of electrical energy flow across diverse operating environments without reliance on static control rules.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

What is claimed is:

1. A system for managing electrical energy flow between a plurality of energy sources and a plurality of electrical load categories, the system comprising:
a first energy management module operatively connected with the plurality of energy sources comprising: a utility grid, one or more grid-tied distributed energy resources (DERs), one or more off-the-grid DERs, configured to establish the electrical energy flow to the plurality of electrical load categories, the first energy management module, comprising:
one or more first energy monitoring units operatively connected to the plurality of energy sources, configured to determine one or more electrical parameters at a pre-defined sampling rate;
an automatic transfer switch (ATS) operatively connected to the one or more first energy monitoring units, configured to selectively connect one of:
the utility grid to the plurality of electrical load categories; and
the one or more off-the-grid DERs to at least one electrical load category within the plurality of electrical load categories;
a first energy switch module operatively connected between the grid-tied DERs and the utility grid, configured to:
one of: electrically connect and electrically disconnect the one or more grid-tied DERs from the utility grid; and
avert electrical energy flowback between the one or more off-the-grid DERs and the one or more grid-tied DERs during a utility grid outage;
a first hardware processor operatively connected to the one or more first energy monitoring units, the ATS, the first energy switch module, configured to:
determine availability conditions of the utility grid and the one or more off-the-grid DERs;
transmit switching control signals to the ATS based on the determined availability condition of the utility grid and the one or more off-the-grid DERs;
transmit one or more connection control commands to the first energy switch module; and
execute a reconnection delay before re-engaging the utility grid to safeguard the at least one electrical load category within the plurality of electrical load categories from electrical failures and voltage spikes; and
a second energy management module operatively connected to the first energy management module, the second energy management module comprising:
a second hardware processor; and
a memory unit operatively connected to the second hardware processor, wherein the memory unit comprises a set of instructions in form of a plurality of subsystems, configured to be executed by the second hardware processor, wherein the plurality of subsystems comprises:
a data obtaining subsystem configured to obtain:
user-defined configuration data comprising DERs group data, first-priority loads group data, and second-priority loads group data;
the availability conditions of the utility grid and the one or more off-the-grid DERs from the first hardware processor;
the one or more electrical parameters from the one or more first energy monitoring units and one or more second energy monitoring units associated with the plurality of electrical load categories; and
at least one of: contextual operational data, and external operational data from one or more data sources;
a forecasting subsystem configured to process the obtained one or more electrical parameters, the availability conditions, and at least one of: the contextual operational data, and the external operational data, using one or more artificial intelligence models for forecasting energy management analytics;
a load prioritization subsystem configured to assign priority designation to the plurality of electrical load categories based on the user-defined configuration data and available electrical energy at the one or more off-the-grid DERs;
an optimization subsystem configured to determine one or more energy distribution commands based on the energy management analytics and the assigned priority designation to the plurality of electrical load categories; and
a control instruction subsystem configured to transmit the one or more energy distribution commands to the first hardware processor for at least one of:
switching the ATS;
selectively one of: connecting and disconnecting the one or more grid-tied DERs; and
managing the electrical energy flow from the plurality of energy sources to the plurality of electrical load categories according to the assigned priority designation.

2. The system of claim 1, wherein the first energy management module further comprises a rectifier module,
the rectifier module operatively connected to the utility grid and the one or more off-the-grid DERs, configured to:
convert alternating current (AC) electrical energy into direct current (DC) electrical energy; and
provide the DC electrical energy to the first hardware processor and the second hardware processor to maintain operational continuity during power transitions and the utility grid outages.

3. The system of claim 1, wherein
the one or more electrical parameters comprise voltage, current, and frequency; and
the pre-defined sampling rate is up to one megahertz.

4. The system of claim 1, wherein the one or more first energy monitoring units and the one or more second energy monitoring units comprise bidirectional metering and isolated metering configured to determine at least one of: electrical energy consumption data and electrical energy generation data.

5. The system of claim 1, wherein the one or more connection control commands comprise one of: commands to disconnect the one or more grid-tied DERs from the utility grid during the utility grid outage and reconnect the one or more grid-tied DERs after the reconnection delay.

6. The system of claim 1, wherein the second hardware processor operatively connected to a communication gateway module,
the communication gateway module configured to:
provide network connectivity to system components and external devices using at least one of: wired communication protocols and wireless communication protocols; and
forward inference requests from the external devices to the second hardware processor and return inference responses to the external devices.

7. The system of claim 1, wherein
the contextual operational data comprises at least one of: historical load profiles, time information, voltage data of rechargeable power sources, utility energy pricing information, and demand pricing information; and
the external operational data comprises at least one of: weather data, utility grid uptime and downtime records, and broadcast data affecting electrical services.

8. The system of claim 1, wherein the one or more artificial intelligence models comprise at least one of:
one or more ensemble methods comprising random forest methods, gradient boosting machine methods, and decision tree methods; and
one or more deep learning models comprising at least one of: artificial neural network (ANN) models, recurrent neural network (RNN) models, long short term memory (LSTM) network models, and transformer-based architecture models.

9. The system of claim 1, wherein the one or more artificial intelligence models are trained using training data comprising at least one of: the historical load profiles comprising voltage data, current data, and frequency measurements, source availability logs comprising the utility grid uptime and downtime records, battery discharge curves, the weather data, historical usage logs, anomaly datasets for failure prediction, and interaction data for decision-making optimization.

10. The system of claim 1, wherein the energy management analytics comprises at least one of: predicting energy consumption data, predicting grid failure events, determining load prioritization, and optimizing use of one or more DERs.

11. The system of claim 1, wherein the forecasting subsystem further configured to perform edge computing for at least one of: real-time data processing, immediate anomaly detection, and local data aggregation to diminish for operation during network disruptions.

12. The system of claim 1, wherein the one or more energy distribution commands comprise:
energizing the plurality of electrical load categories comprising: one or more DERs groups, a first-priority loads group, and a second-priority loads group, based on the electrical energy being supplied from the utility grid;
switching the ATS to supply the electrical energy from the one or more off-the-grid DERs based on the available electrical energy at the one or more off-the-grid DERs being within a first predefined threshold range, and configured to energize the first-priority loads group and configured to averting electrical energy flowback to the one or more off-the-grid DERs and de-energize the second-priority loads group;
switching the ATS to supply the electrical energy from the one or more off-the-grid DERs based on available electrical energy at the one or more off-the-grid DERs being within a second predefined threshold range, and configured to energize a first prioritized sub-group and a second prioritized sub-group in the first-priority loads group and to de-energize a third-prioritized sub-group in the first-priority loads group; and
switching the ATS to supply the electrical energy from the one or more off-the-grid DERs based on available electrical energy at the one or more off-the-grid DERs being within a third predefined threshold range, and configured to energize the first prioritized sub-group in the first-priority loads group and to de-energize the second prioritized sub-group and the third-prioritized sub-group in the first-priority loads group.

13. The system of claim 1, wherein each electrical load in the plurality of electrical load categories comprises:
one or more circuit breakers configured to provide overcurrent protection;
the one or more second energy monitoring units corresponding to the one or more circuit breakers, configured to measure electrical energy consumption with the bidirectional metering and the isolated metering; and
one or more energy control modules corresponding to the one or more circuit breakers, configured to selectively control the electrical energy flow to each electrical load in the plurality of electrical load categories based on the assigned priority designation.

14. The system of claim 1, wherein the plurality of subsystems further comprises:
an energy cost optimization subsystem configured to:
process the utility energy pricing information and the demand pricing information;
analyze electrical energy consumption history and electrical energy generation history derived from the one or more electrical parameters to generate electrical energy analysis data;
compute an energy cost optimization threshold range based on the electrical energy analysis data with respect to the utility energy pricing information and the demand pricing information; and
transmit a disconnection command to the first hardware processor to disconnect the one or more grid-tied DERs from the utility grid through the first energy switch module once electrical energy generation exceeds the energy cost optimization threshold range.

15. The system of claim 1, wherein the plurality of subsystems further comprises:
an economic performance analysis subsystem configured to generate economic performance analysis reports based on at least one of: the utility energy pricing information, the demand pricing information, net metering credits, electrical energy savings, and system installation costs.

16. A method for managing electrical energy flow between a plurality of energy sources and a plurality of electrical load categories, the method comprising:
establishing, by a first energy management module operatively connected with the plurality of energy sources comprising: a utility grid, one or more grid-tied distributed energy resources (DERs), and one or more off-the-grid DERs, the electrical energy flow to the plurality of electrical load categories;
determining, by one or more first energy monitoring units operatively connected to the plurality of energy sources, one or more electrical parameters at a pre-defined sampling rate;
selectively connecting, by an automatic transfer switch (ATS) operatively connected to the one or more first energy monitoring units, one of:
the utility grid to the plurality of electrical load categories; and
the one or more off-the-grid DERs to at least one electrical load category within the plurality of electrical load categories;
performing, by a first energy switch module operatively connected between the one or more grid-tied DERs and the utility grid, at least one of:
one of: electrically connecting and electrically disconnecting the one or more grid-tied DERs from the utility grid; and
averting electrical energy flowback between the one or more off-the-grid DERs and the one or more grid-tied DERs during a utility grid outage;
determining, by a first hardware processor operatively connected to the one or more first energy monitoring units, the ATS, and the first energy switch module, availability conditions of the utility grid and the one or more off-the-grid DERs;
transmitting, by the first hardware processor, switching control signals to the ATS based on the determined availability conditions of the utility grid and the one or more off-the-grid DERs;
transmitting, by the first hardware processor, one or more connection control commands to the first energy switch module;
executing, by the first hardware processor, a reconnection delay before re-engaging the utility grid to safeguard the at least one electrical load category within the plurality of electrical load categories from electrical failures and voltage spikes;
obtaining, by a data obtaining subsystem executed by a second hardware processor of a second energy management module operatively connected to the first energy management module:
user-defined configuration data comprising DERs group data, first-priority loads group data, and second-priority loads group data;
the availability conditions of the utility grid and the one or more off-the-grid DERs from the first hardware processor;
the one or more electrical parameters from the one or more first energy monitoring units and one or more second energy monitoring units associated with the plurality of electrical load categories; and
at least one of: contextual operational data, and external operational data from one or more data sources;
processing, by a forecasting subsystem executed by the second hardware processor, the obtained one or more electrical parameters, the availability conditions, and at least one of: the contextual operational data, and the external operational data, using one or more artificial intelligence models to forecast energy management analytics;
assigning, by a load prioritization subsystem executed by the second hardware processor, priority designation to the plurality of electrical load categories based on the user-defined configuration data and available electrical energy at the one or more off-the-grid DERs;
determining, by an optimization subsystem executed by the second hardware processor, one or more energy distribution commands based on the energy management analytics and the assigned priority designation to the plurality of electrical load categories; and
transmitting, by a control instruction subsystem executed by the second hardware processor, the one or more energy distribution commands to the first hardware processor for at least one of:
switching the ATS;
selectively one of: connecting and disconnecting the one or more grid-tied DERs; and
managing the electrical energy flow from the plurality of energy sources to the plurality of electrical load categories according to the assigned priority designation.

17. The method of claim 16, wherein the one or more energy distribution commands comprise:
energizing the plurality of electrical load categories comprising: one or more DERs groups, a first-priority loads group, and a second-priority loads group, based on the electrical energy being supplied from the utility grid;
switching the ATS to supply the electrical energy from the one or more off-the-grid DERs based on the available electrical energy at the one or more off-the-grid DERs being within a first predefined threshold range, and configured to energize the first-priority loads group and configured to averting electrical energy flowback to the one or more off-the-grid DERs and de-energize the second-priority loads group;
switching the ATS to supply the electrical energy from the one or more off-the-grid DERs based on available electrical energy at the one or more off-the-grid DERs being within a second predefined threshold range, and configured to energize a first prioritized sub-group and a second prioritized sub-group in the first-priority loads group and to de-energize a third-prioritized sub-group in the first-priority loads group; and
switching the ATS to supply the electrical energy from the one or more off-the-grid DERs based on available electrical energy at the one or more off-the-grid DERs being within a third predefined threshold range, and configured to energize the first prioritized sub-group in the first-priority loads group and to de-energize the second prioritized sub-group and the third-prioritized sub-group in the first-priority loads group.

18. The method of claim 16, further comprising:
processing, by an energy cost optimization subsystem executed by the second hardware processor, utility energy pricing information, and demand pricing information;
analyzing, by the energy cost optimization subsystem, electrical energy consumption history and electrical energy generation history derived from the one or more electrical parameters to generate electrical energy analysis data;
computing, by the energy cost optimization subsystem, an energy cost optimization threshold range based on the electrical energy analysis data with respect to the utility energy pricing information and the demand pricing information; and
transmitting, by the energy cost optimization subsystem, a disconnection command to the first hardware processor to disconnect the one or more grid-tied DERs from the utility grid through the first energy switch module once electrical energy generation exceeds the energy cost optimization threshold range.

19. The method of claim 16, further comprising:
generating, by an economic performance analysis subsystem executed by the second hardware processor, economic performance analysis reports based on at least one of: the utility energy pricing information, the demand pricing information, net metering credits, electrical energy savings, and system installation costs.

20. A non-transitory computer-readable storage medium having a set of instructions stored therein that when executed by a first hardware processor and a second hardware processors, cause the first hardware processor and the second hardware processors to execute operations of:
determining availability conditions of a utility grid and one or more grid-tied distributed energy resources (DERs);
transmitting switching control signals to an automatic transfer switch (ATS) based on the determined availability condition of the utility grid and one or more off-the-grid DERs;
transmitting one or more connection control commands to a first energy switch module operatively connected between the one or more grid-tied DERs and the utility grid, to:
one of: electrically connect and electrically disconnect the one or more grid-tied DERs from the utility grid; and
avert electrical energy flowback between the one or more off-the-grid DERs and the one or more grid-tied DERs during a utility grid outage;
executing a reconnection delay before re-engaging the utility grid to safeguard at least one electrical load category within a plurality of electrical load categories from electrical failures and voltage spikes;
obtaining user-defined configuration data comprising DERs group data, first-priority loads group data, and second-priority loads group data;
obtaining the availability conditions of the utility grid and the one or more off-the-grid DERs;
obtaining one or more electrical parameters from one or more first energy monitoring units and one or more second energy monitoring units associated with the plurality of electrical load categories;
obtaining at least one of: contextual operational data, and external operational data from one or more data sources;
processing the obtained one or more electrical parameters, the availability conditions, and at least one of: the contextual operational data, and the external operational data, using one or more artificial intelligence models to forecast energy management analytics;
assigning priority designation to the plurality of electrical load categories based on the user-defined configuration data and available electrical energy at the one or more off-the-grid DERs;
determining one or more energy distribution commands based on the energy management analytics and the assigned priority designation to the plurality of electrical load categories; and
transmitting the one or more energy distribution commands for:
switching the ATS;
selectively one of: connecting and disconnecting the one or more grid-tied DERs; and
managing the electrical energy flow from the plurality of energy sources to the plurality of electrical load categories according to the assigned priority designation.
